(19) United States
(12) Patent Application Publication
(10) Pub. No.: US 2021/0131095 A1
(43) Pub. Date: May 6, 2021

(54) VARIABLE ACOUSTIC TECHNOLOGY FOR ROOMS

(71) Applicant: Niels Werner Adelmann-Larsen, Copenhagen (DK)

(72) Inventor: Niels Werner Adelmann-Larsen, Copenhagen (DK)

(21) Appl. No.: 16/491,532

(22) PCT Filed: Mar. 4, 2018
(86) PCT No.: PCT/DK2018/000005

§ 371 Date: Sep. 5, 2019

(30) Foreign Application Priority Data
Mar. 5, 2017 (DK) PA 2017 00153

(51) Int. Cl. E04B 1/99; E04B 1/86; E04B 9/00; G10K 11/162

(52) U.S. Cl. CPC E04B 1/994; E04B 1/86; G10K 11/162; E04B 9/001; E04B 9/003

(57) ABSTRACT

Modules with variable acoustic properties configured for covering boundaries, such as walls or ceilings of a room, for instance a multi-purpose room, in which it must be possible to change the acoustical properties of the room, such as the reverberation time, according to each specific use, where the module has a front face provided with one or more through-openings through which sound energy can enter an inner region of the module, and where the module in the inner region comprises a sound absorbing device in acoustic communication with the through-openings in the front face such that sound energy can pass from an exterior region or space outside the module to said sound absorbing device, where the through-openings can be closed, such that sound energy cannot enter the sound absorbing device and opened, such that sound energy can enter the sound absorbing device.

### TECHNICAL FIELD

The present invention relates generally to the field of room acoustics and more particularly to devices, systems and methods for altering the reverberation time of rooms, auditoria or other locations, in which various kinds of live performances are to take place, such that the reverberation time can be optimized to each specific kind of live performance.

### BACKGROUND OF THE INVENTION

Worldwide, multi-purpose rooms or halls are used and especially in connection with such rooms or halls it is a big advantage if the reverberation time can be changed according to each specific need. Thus, for instance the performance of amplified music such as pop and rock may require a relatively short reverberation time especially at low frequencies, whereas performance of classical or choral music may require a longer reverberation time in order to sound as good as possible.

Means for altering the acoustic characteristics of a room are well known in the art. Thus, for instance U.S. Pat. No. 8,573,356 B1 describes an adjustable sound panel having a sound diffusing element and a sound absorbing element. The panel can be varied between a state in which maximal sound absorption is obtained by opening passageways extending from the front of the panel to the rear of the panel where a suitable sound absorbing material is provided. The front face of the panel is configured as a sound diffusor comprising a pattern of slats with openings between adjacent slats. When mounted in a room, the visual appearance of the room is altered.

U.S. Pat. No. 9,322,165 B2 describes a dynamically adjustable acoustic panel device, at the front face of which there is provided a plurality of relatively small (compared to the entire acoustic panel device) square panel elements that have a sound diffusing effect. These small panels can each be rotated about an axis whereby the panel device can be brought to a sound absorbing state as the rotated small panels provide sound access to a region behind the panel device, in which a suitable sound absorbing material is provided. As in the case of the above cited U.S. Pat. No. 8,573,356 B1 the provision of the panel device alters the visual appearance of the room, when mounted herein.

U.S. Pat. No. 6,431,312 B1 describes a motorized and computer-operated variable acoustic treatment that comprises a plurality of acoustical treatments located in a space separated from other acoustical treatments. The acoustic treatment comprises rotating units that can be rotated about their individual axes by means of a motor, which can be controlled by a user via a user interface. As in the case of the above cited U.S. Pat. No. 8,573,356 B1 and U.S. Pat. No. 9,322,165 B2, the provision of the variable acoustic treatment alters the visual appearance of the room, when mounted herein.

EP 1 779 375 B1 describes devices, systems and a method for altering the reverberation time of a room or hall, especially at lower frequencies, where the reverberation time is altered by the introduction of inflatable bodies with suitable acoustic characteristics in the room. When a reduction of reverberation time is desired, the bodies are inflated. The provision of the bodies described in this document in a room will in most cases alter the visual appearance of the room significantly, unless they are provided in regions of the room that are not illuminated.

DE 202007006877 U1 describes a variable acoustics module and groupings of these. A hall comprising a stage on which sound energy is generated and an audience area is shown. The boundaries of the hall comprise areas covered with the mentioned variable acoustic modules. The modules are configured with pivotable plates on the outside of the module, such that they can pivot between an open state, in which sound can reach the absorbing portions and a closed state, in which sound is blocked from reaching the absorbing portions.

None of the devices described in the above-mentioned documents disclose retaining means for opening/closing plates that ensures that an acoustically tight closing is achieved. Further, none of the devices described in the above-mentioned documents disclose a front face on which a sheet can be mounted.

Acoustic variability of concert spaces has been sought after for decades. Various kinds of program material such as a rock concert, a chamber music concert, a choir or a theater play all need different acoustics to sound well in the same space. Recommendations expressed as suitable reverberation times (RT) for various types of music have been set forth by several authors and researchers in the field, for instance Beranek (1954) [3], Knudsen (1958) [4], Egan (1988) [5], Makrinenko (1994) [6], Long (2006) [7] and Adelman-Larsen (2010, 2018, 2014) [1, 2, 8]. In [1] it was demonstrated that what makes a hall suitable for amplified music is first and foremost a rather low reverberation time at low frequencies (especially 125 Hz, but to some extend also the 63 and 250 Hz octave bands). Further, in [2] it was substantiated that the reverberation time at higher frequencies above some 500 Hz can be much longer for amplified music.

The organization Standard Norway has set forth recommendations for reverberation times (RT) as a function of frequency band and volume-of-hall for various types of music in the standard NS 8178. In that standard it is seen that for a hall of a given size, RT should be approximately half as long in the frequency bands 125 Hz to 500 Hz for pop and rock music than for a chamber music setting in a typical performing arts center. However, today many performing arts centers worldwide actually do present such different types of music on a weekly basis without nearly reaching this variability resulting in non-optimal acoustics and thereby sound experience for musicians and audience.

The required large variation of RT as mentioned, has not previously been possible to achieve since, according to the laws of physics (as for instance seen in the famous Sabine's formula), this requires very large areas covered with variable acoustic means, all of which must enable a very big span of variability in the important frequency bands including the 125 Hz band. The variability span per area unit can be expressed by the difference of the absorption coefficient alpha a, in the absorbent state of the technology compared to the non-absorbent state. This variation can be called delta alpha, Δα (α_{ON} minus α_{OFF}).

Formerly, variable acoustics devices have mainly been active at mid—to high frequencies and not so much at low frequencies. In Adelman-Larsen's scientific article from 2018 (Applied Acoustics, [ref. 2]) it is shown that this is not suitable. Variability should be focusing on the 125 Hz octave band, and be most active from 63 Hz to 1 kHz i.e. at low and mid frequencies, with only little absorption above some 1 kHz.

Further, it cannot be assumed that stake holders such as audiences, hall owners or architects are willing to accept that the interior design of the hall is profoundly affected by the presence of visually compromising variable acoustic devices such as roll banners etc. on very large surface areas. “Invisible” variable acoustics devices would thus be desirable.

On the above background it would be desirable to have access to a variable acoustic technology to be used in a room or hall which technology could alter acoustic characteristics, especially the reverberation time, of a room or hall without thereby altering the visual appearance of the room or hall when the acoustic characteristics of the acoustic technology is altered. This technology should preferably be configured to allow easy integration into the interior design of an existing room or hall as well as into new constructions of rooms and halls.

Since large areas must be used to obtain the large variability already mentioned, it would be a further advantage if the acoustic technology could be mounted on both ceiling (horizontal) and walls (vertical) surfaces.

### DISCLOSURE OF THE INVENTION

On the above background it is an object of the present invention to provide means for varying the reverberation time in rooms, auditoria and the like such as—but in no way limited to —concert halls or other rooms in which music is to be performed, theatres, cinemas and multi-purpose rooms or halls. The means according to the present invention must fulfill at least two requirements:

(1) They must facilitate changing the reverberation time at mid and low frequencies, of the room or hall in which they are used without changing the reverberation time at higher frequencies for example above 1000 Hz as much. This is according to the principles of the present invention accomplished by the provision of sound absorbing units or modules (in the following referred to as modules) that are provided with means for absorbing sound, wherein the sound absorption at mid and low frequencies can be varied between substantially no absorption of incident sound energy and a very high absorption of incident sound energy. This large variation of sound absorption is especially desirable in the lower frequency range, for instance at frequencies below 500 Hz. It is, however understood that specific values of frequencies mentioned in the context of the present invention should not be regarded as limiting the scope of protection of the invention and should only be regarded as exemplary.

Thus, for instance, optimal frequency ranges of sound absorption may among many other factors depend on the specific use of a room or hall.

(2) The means according to the present invention must provide an aesthetical solution that can be widely accepted by architects or other decision makers involved in the interior design of either existing rooms or halls, or in new constructions hereof. Preferably, the means according to the present invention must be configured for integration in existing or new rooms or halls. Preferably, the means according to the present invention must, when provided in a room or hall, present one or more by appearance uniform or even unbroken surfaces extending for instance over chosen boundary portions of the room or hall. Thus, for instance, a complete wall or ceiling (or portions hereof) of a multi-purpose hall will, after the provision of the wall with modules or systems according to the present invention present a seemingly unbroken surface extending over the entire wall or ceiling or chosen portions hereof and have a unified appearance to an observer located in the hall. This appearance will according to the present invention not change when the acoustic properties of the boundary provided with the means according to the invention are altered with the aim to for instance alter the reverberation time of the room or hall. Specifically, it may under circumstances be advantageous by simple means (such as lighting or projection of pictures etc.) on surface portions of the means according to the invention to be able to change the visual appearance of for instance a wall or ceiling on which the means according to the invention are provided.

### First Aspect of the Present Invention

The first aspect of the present invention relates to a sound absorbing module, where the module has two sound absorption states: (i) an open state, in which the module absorbs sound energy in at least the low-frequency region (a more specific definition of low-frequency region is given below), and (ii) a closed state, in which the module absorbs substantially no sound energy. The module according to the first aspect comprises basically a front face with an opening/closing mechanism and a sound absorbing devise. An embodiment of a module according to the first aspect of the invention is shown in FIG. 18.

The above and other objects and advantages is according to the first aspect of the invention provided by a module with variable acoustic properties configured for covering boundaries, such as walls or ceilings of a room, for instance a multi-purpose room, in which it must be possible to change the acoustical properties of the room, such as the reverberation time, according to each specific use, where the module has a front face provided with one or more through-openings through which sound energy can enter an inner region of the module, and where the module in the inner region comprises a sound absorbing device in acoustic communication with the through-openings in the front face such that sound energy can pass from an exterior region or space outside the module to the sound absorbing device, where the through-openings can be closed, such that sound energy cannot enter the sound absorbing device via the through-openings and opened, such that sound energy can enter the sound absorbing device via the through-openings, where the front face is provided with an opening/closing mechanism comprising a closing member and a retaining mechanism, which retaining mechanism is configured such that it maintains the closing member in contact with substantively the entire circumference the through-openings, when the module is in a closed state.

When the module is to be brought from a closed state to an open state, a force is exerted by the actuator or motor via the opening/closing mechanism that urges the closing member away from its contact with the corresponding surface of the front face, whereby the retaining mechanism loses its closing grip on the closing member, such that the module can be brought into the open state. Some practical implementations of retaining mechanisms using magnetic means or mechanical means, respectively, are shown in the figures and described in greater detail in the detailed description of the invention.

In order to be able to obtain the required variation of the reverberation of a room, such as a multi-purpose room which is the core object of the present invention, it is essential that the opening/closing mechanism is designed such that it actually provides a very tight acoustic closing of the through-openings in the front face, when the front face is in the closed state. Only a very limited amount of sound energy is at low frequencies, especially in the 125 and 250 octave bands allowed to pass through the front face and reach the sound absorbing device behind the front face. According to the invention, this is in fact obtained as will be shown by actual measurements reproduced in FIG. 8 of the detailed description. For the closing mechanism to function sufficiently well in order to effectively block sound entrance to the sound absorbing device, the invention proposes the application of the above-mentioned retaining means that actually substantively (or preferably totally) ensures that a first closing face of the closing means used in the opening/closing mechanism remains in contact with a second closing face, where theses closing faces preferably extend along the entire circumference of the through-openings in the front face.

Another (and supplementary) means of ensuring that only a very limited amount of sound energy reaches the sound absorbing device in the closed state of the module is to choose a material for the opening/closing means (as well as for the entire front face) that has a high mass per unit area.

In an embodiment of the first aspect, the opening/closing mechanism is configured such that it maintains a plane front face in all states of the opening/closing mechanism, whereby it becomes possible to attach a sound permeable covering sheet to the outer surface of the front face or in the vicinity (preferably less than 2 cm, still more preferably less than 5 mm) to the outer surface of the front face, where the outer surface of the front face is the surface of the module facing an exterior region or space.

In an embodiment of the first aspect, the surface of the front face facing the exterior region or space is covered by a covering sheet that is configured such that it is possible for sound energy to enter the sound absorbing device through the sheet and through the through-openings, when the through openings are in the open state.

In a practical implementation of the module according to the first aspect, it may be important that the covering sheet is provided as close as possible to the outer surface of the front face in order to minimize a Helmholz resonator effect of a space (volume) formed between the covering sheet and the outer surface of the front face in combination with the acoustic mass of the through-going openings in the front face. Further, on order to minimize a Helmholz effect, it is possible to provide the opening/closing mechanism with means that in the closed state of the front face fills the through-openings. An embodiment of such means will be described in the detailed description of the invention.

Another advantage obtained by providing the covering sheet on or in the close vicinity of the outer surface of the front face is that unwanted sound diffusion caused by the perforation in the sheet is minimized whereby a remaining sound absorption in the closed state of the module would lead to less variability of the sound absorption coefficient. Sound diffusion would lead to a constant, unwanted lower value of the reverberation time in the room.

According to the invention, the above mentioned sound absorbing device could be a bat of a mineral wool or other suitable porous material, but the sound absorbing devise is in the context of the present invention to be understood broadly, also comprising for instance Helmholz resonators designed to absorb sound in relatively narrow frequency ranges. The sound absorbing device according to the present invention could also comprise combinations of different sound absorbing devices, if desired for specific purposes.

The above-mentioned inner (or interior) region can be a region or space formed between the module and a corresponding surface portion of a boundary of the room, for instance a ceiling or a wall. The inner region could also be the region or space formed between a plurality of modules used in a system according to the second aspect of the invention described below and the corresponding surface portions of the boundaries of the room in which the modules are installed. In a specific embodiment of the first and second aspects of the invention, the module may be configured as a separate enclosure comprising an interior space in which the above mentioned sound absorbing device is provided. Thus, a module according to the invention can either be a separate physical entity or be a combination comprising at least a suitable designed front face (as described in detail below), a suitably designed sound absorbing device and a region or space formed between the front face and the corresponding portion of a boundary in the room, in which the module according to the invention is installed. As one consequence of this, modules according to some of the embodiments described below can be assembled on site, and for instance a portion of the structure forming the modules can be installed first and subsequently be provided with the remaining parts of the complete module.

The exterior region or space (S) outside the module is the region of a room or other enclosure in which the modules according to the invention (or various systems of such modules) are provided, in which exterior region the reverberation time must be varied according to different specific uses of the room or enclosure. Such different uses could for instance be live performances of pop or rock music, classical music, opera, jazz, as well as the use of the room or enclosure as an auditorium or as a cinema.

In some embodiments, the module according to the first aspect basically comprises three entities:

(1) a frame structure that can be used to hold the front face and the sound absorbing device together, where the frame structure defines the inner region of the module in which inner region the sound absorbing device (or a plurality of sound absorbing devices) is provided;

(2) a front face that is provided with the above mentioned through-openings that, when in the open state, provides sound access from the sound field in the room or hall to the one or more sound absorbing devices provided in the inner region of the module; and

(3) one or more sound absorbing devices provided in the inner region of the frame structure and being in acoustic communication with the through-openings in the front face. Although it is possible to manufacture the frame and the front face as one integrated unit, it may in practice by preferable to provide the frame as one entity and the front face as another entity. This allows the frame structure initially to be mounted on the chosen boundaries and afterwards, when the frame structure is in place to attach the front face to the frame structure. Typically, the front face will (for typical dimensions and choice of material of the modules) weigh about 35 kg and the corresponding frame structure will typically weigh considerably less than 12 kg. During installation, it is hence much easier to handle the frame structure as one separate entity and afterwards to attach the front face to the frame structure. If a front panel according to the first aspect of the invention during installation is to be manually handled by a single person, the weight of the front face should preferably not exceed about 30 kg, but two persons would probably be able manually to handle a front face weighting up to about 45 kg.

In other embodiments, the modules according to the first aspect basically comprises the following four physical entities: (1) a front face provided with through-openings that can be opened and/or closed by a suitable opening/closing mechanism; (2) one or more sound absorbing devices in acoustic communication with the through-openings in the front face; (3) a frame structure comprising substantially sound impermeable side faces extending from the front face and surrounding the one or more sound absorbing devices, such that, when the module is installed in a room, sound energy can only reach the one or more sound absorbing devices via the through-openings in the front face (when these are in the open state); and (4) module attachment means configured to attach the module to a boundary of the room.

In order to obtain sufficient sound insulation at low frequencies by the side faces, these should have a mass per unit area of at least the same as the front face and preferably above approximately 15 kg/m².

In an embodiment of the first aspect, the above-mentioned module attachment means is a substantially rigid frame structure.

In an embodiment of the first aspect, the above-mentioned module attachment means is a plurality of wires attached at one longitudinal end to the module and at the other longitudinal end to for instance a ceiling of a room.

In an embodiment of the first aspect, the above-mentioned module attachment means is a plurality of substantially rigid leg members by means of which a module can be attached for instance to wall portions of a room.

A front face that is only supported at a few positions (for instance at either longitudinal end of the front face) will, depending on its specific configuration, tend to act as a membrane absorber, i.e. the front face will tend to vibrate as it is affected by a sound field generated in the room in which the module is installed. If it is required to prevent the front face from acting as a membrane absorber, the front face can be reinforced by suitable 3-dimensional profiles as shown in the detailed description of the invention.

Varies implementations of front faces suitable in the present invention are conceivable and some of these will be described in more detail in the detailed description of the invention.

In an embodiment of the first aspect, the front face is a thin substantially planar metal sheet with the through-openings provided as an integral part of this sheet.

In an embodiment of the first aspect, the front face is reinforced to improve its rigidity (bending stiffness) for instance by providing the substantially planar front face with stiffening profiles, such as L-profiles. Preferably such profiles may be provided on the surface of the front face that faces the inner region of the module.

In an embodiment of the first aspect, the front face is curved.

In an embodiment of the first aspect, lightning means, such as LEDs, are placed in the through-openings, which LEDs may emit light for instance when the through-openings are in the open state. Alternatively, lighting means could be placed in the inner region of the modules and being visible via the through-openings, when these are in the open state.

In an embodiment of the first aspect, the covering sheet is made of a material comprising veneer or foil provided with perforations at least in those regions of the covering sheet that cover the through-openings in the front face. For instance, the sheet could be a gypsum panel provided by a layer of veneer both with appropriate openings in front of the through-openings of the module at the surface that faces the exterior region outside the module.

In an embodiment of the first aspect, the covering sheet is a fabric that is substantially sound permeable at least at low frequencies.

In an embodiment of the first aspect, an intermediate sheet or panel is provided between the front face and the covering sheet, which intermediate sheet or panel is acoustically permeable, at least in the low-frequency region where sound absorption is desired when the module is in the open state, at least in those regions of the intermediate sheet or panel that correspond to the through-openings in the front face.

In an embodiment of the first aspect, the sound absorbing device is a bat of for instance mineral wool or other porous material that absorb sound energy where the material is provided in a region, wherein a large particle velocity of the sound waves exists.

In an embodiment of the invention, the sound absorbing device comprises one or more Helmholz resonators. Such resonators, when correctly tuned, provide a high sound absorption in a narrow frequency band. According to the invention, one or more Helmholz resonators may either by themselves form the sound absorbing device or may be combined with one or more bats of mineral wool or other porous material.

In an embodiment of the first aspect, the module comprises an opening/closing mechanism configured to obtain a substantially acoustically tight closing of the through-openings, where the mechanism comprises a first and a second closing face, where the mechanism is configured such that it closes the through-openings, when the first and second closing faces are in contact with each other and opens the through-openings, when the first and second contact faces are not in contact with each other.

In an embodiment of the first aspect, at least one of the first or the second closing faces is provided with magnetic means functioning as a retaining mechanism configured to urge the first closing face against the second closing face, when the mechanism is brought into the closed state.

In an embodiment of the first aspect, the first closing face is provided with a permanent magnetic material functioning as a retaining mechanism, and the second closing face is made of a material that can be attracted by the magnetic material of the first closing face.

In an embodiment of the first aspect, the first contact face is provided with an electro magnet functioning as a retaining mechanism, and the second contact face is made of a material that can be attracted by the electro magnet of the first contact face.

In an embodiment of the first aspect, the means for opening and/or closing comprises an actuator or motor means operatively connected to the means for opening and/or closing the through-openings, which actuator or motor means can be remote controlled by a user from a user interface.

In an embodiment of the first aspect, the opening/closing mechanism comprises a pivotally mounted plate member that is configured to pivot about a pivot axle in fixed relationship with the front face, such that the plate member can pivot between a closed state, where the plate member closes the through-opening in the front face and an open state, where the plate member does not close the through-opening, where the plate member is provided with said first closing face and the front plate on a corresponding portion is provided with said second closing face.

In a preferred embodiment of the first aspect (and of the front face according to the second aspect as well), the plate members provided as opening/closing means for the through-openings in the front face pivot in an inward direction, i.e. into the interior region of the module in which the sound absorbing device is located. This is among others advantageous in that the module barely change its visual appearance when it varies between the open and the closed state. It also ensures that a covering sheet can be mounted even in direct contact with the exterior or front surface of the front face, i.e. the surface of the front face that faces the exterior region or space. Preferably, the sound absorbing device in the interior region of the module will be black and the front face will similarly have a matt black surface, such that it is at least difficult to see a difference between the open and close state of the module, even when a covering sheet is not present in front of the front face. In an embodiment of the first aspect, one of the closing faces is provided with a permanent magnetic material, such as a magnetic ribbon, and the other closing face is made of a material that can be attracted by a magnetic force from the magnetic material provided on the opposing closing face.

In an embodiment of the first aspect, the opening/closing mechanism comprises a sliding plate member mounted for a sliding movement substantially in parallel with the front face, such that the sliding plate member can move between a closed state, in which it closes the through-opening in the front face and on open state, in which it does not close the through-opening in the front face.

In an embodiment of the first aspect, the sliding plate member at opposing edge portions in the direction of movement is provided with leg portions, such that the sliding plate member has a general U-shape, and where the front face is provided with corresponding leg portions at the edges of the through-opening extending perpendicularly to the direction of movement of the sliding plate member, such that one leg portion of the sliding plate member corresponds to one leg portion of the front plate and the other leg portion of the sliding plate member corresponds to the other leg portion of the front face, where the first leg portion of the sliding plate member in the closed state of the opening/closing mechanism is substantially in contact with the corresponding leg portion of the front face and the other leg portion of the sliding plate member is substantially in contact with the corresponding leg portion of the front face, whereby the through-opening in the fornt face is substantially closed.

In an embodiment of the first aspect, one of the leg portions of the sliding plate member is provided with a magnetic material configured to urge said leg portion towards the corresponding leg portion on the front face and/or where the other leg portion is provided with a magnetic material configured to urge said other leg portion towards the corresponding other leg portion on the front face, when the opening/closing mechanism is brought into the closed state.

In an embodiment of the first aspect, the opening/closing mechanism comprises an opening/closing plate member extending substantially in parallel with front face and covering the through-opening in the front face, such that an overlapping closing region is formed between the edge portions of the plate member and the corresponding edge regions of the front face adjacent to the through-opening, where the opening/closing mechanism comprises actuator means (such as a linear actuator, a motor or any other means suitable for driving the opening/closing mechanism) connected to the plate member configured to move the plate member in a direction substantively perpendicular to the front face between a closed state, in which the plate member closes the through-opening and an open state, in which the plate member does not close the through-opening.

In an embodiment of the first aspect, either the overlapping closing region or the corresponding edge regions or both of these regions/portions are provided with magnetic means, which magnetic means is configured to urge the overlapping closing region towards the corresponding edge region, when the opening/closing mechanism is in the closed state.

In an embodiment of the first aspect, the opening/closing means comprises actuator means configured to move the opening/closing mechanism between the open state and the closed state.

In an embodiment of the first aspect, the sound absorbing device is configured to absorb mid- and low-frequency sound energy, preferably at frequencies below 1000 Hz.

In an embodiment of the first aspect, the front face comprises a plurality of through-openings provided as an integral part of the front face.

In an embodiment of the first aspect, the front face is made of a material that can be attracted by a magnetic force.

In an embodiment of the first aspect, the front face is made of metal, such as steel.

In an embodiment of the first aspect, the thickness t of front face is 4 mm or less, preferably less than 3 mm.

In an embodiment of the first aspect, the front face comprises a plurality of slats with the through-openings provided between adjacent slats.

In an embodiment of the first aspect, the slats are made of metal, such as steel.

In an embodiment of the first aspect, the thickness t of the slats is less than 4 mm, preferably less than 3 mm.

In an embodiment of the first aspect, the slats have a front face that is substantially plane.

In an embodiment of the first aspect, the front face is provided with attachment means configured to attach the sheet and/or the intermediate sheet or panel provided with the sheet to the front face of the module, whereby the sheet and/or the intermediate sheet or panel provided with the sheet can be attached to the module after the module has been mounted on a boundary of a room or hall.

In an embodiment of the first aspect, the side faces of the module that together with the front face define the inner region of the module are closed by acoustically substantially impermeable plate elements to prevent acoustic energy in the surroundings from reaching the interior space of the module containing the opening/closing mechanism and the sound absorbing device.

In an embodiment of the first aspect, the covering sheet is made of a material that is acoustically sufficiently permeable at least in the low-frequency region to allow the module to have its sound absorptive effect in the open state of the through-opening in the module. For instance, a sheet of fabric could be used in specific embodiments of the invention.

In an embodiment of the first aspect, an intermediate sheet or panel is provided between said front face and said covering sheet. In practical implementations of the various aspects of the present invention, it is necessary that such intermediate sheets or panels compile with any legal regulations (such as fire regulations) in the countries in which the invention is to be applied. Thus, for instance, the intermediate sheet or panel could be a gypsum board material or fiber cement board material or simply thin metal plates etc., in all cases appropriately perforated in front of the through-openings in the front face. For instance, in a practical implementation, veneer could be glued to gypsum board to create a wooden finish in a room, such as a concert hall. The intermediate sheet or panels must be acoustically permeable (at least in the low-frequency region in which sound absorption is desired) at least at the portions of the sheet or panel corresponding to the through-openings in the front face, such that sound energy (in the open state of the module) can pass from the room, in which the module is installed, to the sound absorption device in the module. In an embodiment of the first aspect, the sound absorbing device is configured to absorb mid and low frequency sound energy, preferably at frequencies below 1000 Hz.

In an embodiment of the first aspect, the sound absorbing device is configured to absorb mid and low frequency sound energy, preferably at frequencies below 500 Hz in the open state of the module.

In an embodiment of the first aspect, the sound absorbing device is configured to absorb low frequency sound energy, preferably at frequencies in the 63 Hz, 125 Hz and 250 Hz octave bands in the open state of the module.

In an embodiment of the first aspect, the front face of the module comprises a plurality of slats with the through-openings provided between adjacent slats.

In an embodiment of the first aspect, the slats are made of metal, such as steel. The slats can either be solid or they can be made of acoustically tight closed profiles.

The slats are preferably made of a material that ensures a sufficient surface weight for instance not less than 15 kg/m² in order to obtain a low absorption value even at low frequencies in the closed mode of the through-openings i.e. a high degree of sound reflection at low frequencies in the closed state. Preferably, a sound absorption coefficient of for instance max 0.2 should, in the closed state of the module be obtained in the 125 Hz octave band.

Alternatively, or additionally increasing the rigidity of the front face is obtained by suitable means such as steel profiles (T or L profiles for instance) attached to the rear surface of the front face, i.e. towards the inner region of the module.

The surface weight required to obtain a desired low sound absorption coefficient in the closed state can be loosely estimated from the expression:

$$α = \frac{1}{1 + \frac{2 π fm}{2 ρ c}}$$

where α is the sound absorption coefficient, f is the frequency, m is the surface weight, ρ is the specific mass of air and c is the speed of sound in air. However, in a practical implementation it is necessary to verify that the sound transmission through the front face and closed through-opening is at a satisfactory low level. The absorption coefficient of 0.2 in FIG. 8(b) at 125 Hz is most likely caused by sound transmission through the front face of 2 mm steel possibly in combination with a membrane absorption effect mentioned in the equation above. A lower value would be obtained if the surface weight of the front face was higher, which would lead to a higher sound reduction index.

In an embodiment of the first aspect, the thickness t of the slats is 4 mm or less, preferably less than 3 mm. The thickness of the slats, and hence the depth of the through-openings, should preferably be kept small in order to avoid an undesired Helmholz resonator effect caused by the acoustic mass of the through-openings and the acoustic compliance of the interior space in the modules. The thickness of the slats should preferably be kept small in order to avoid resonator effect between the sheet covering the through-openings in the module and the opening and closing means (see below) that opens or closes sound access through the front face and into the interior region of the module. This resonator effect can further be avoided or reduced by the provision of foam or soft fire retardant plastic strips on the opening and closing means as described in the detailed description of the invention.

In an embodiment of the first aspect, the slats have a front face that is substantially planar. This feature is important in order to make it possible to mount the covering sheet firmly to the outer surface of the front face of the slats.

In an embodiment of the first aspect, the through-openings in the front face are provided with means for opening and/or closing one or more of the through-openings, which means comprises actuator or motor means operatively connected to the means for opening and/or closing the through-openings, which actuator or motor means may be remote controlled by a user from a user interface.

It is important that the through-openings in the front face can be closed acoustically tight if substantially no sound absorption is desired. Embodiments of mechanisms for opening and closing the through-openings in the front face are described in the detailed description of the invention. In the design of these mechanisms it is important to ensure that the required closing is not hindered by for instance accumulation of dust or other particles in the mechanism.

In an embodiment of the first aspect, the front face is provided with attachment means configured to attach the intermediate sheet or panel provided with the covering sheet to the front face of the module, whereby the intermediate sheet or panel provided with the covering sheet can be attached to the module after the module has been mounted on a boundary of a room or hall. Such attachment means can comprise both mechanical attachment means and a suitable adhesive such as glue as well as for instance a Velcro tape or the like.

The thickness of the slats (i.e. their extension from the front face towards the interior space of the module) can according to an embodiment of the invention be increased in order to achieve a slit-absorber type absorption characteristic and the distance between adjacent slats can be made smaller, for instance 1 cm). This can enhance low-frequency absorption.

In an embodiment of the first aspect, the slats are configured as hollow profiles for instance made of metal, such as a 2 mm steel plate.

In order to facilitate maintenance or replacement of the interior parts of the modules, such as the actuator or other drive means, it is desirable to have easy access the interior of the module, when this is installed in the room. In an embodiment of the first aspect, the front face is pivotally attached to the attachment means used to attach the module to the boundary, such that the front face can be tilted relative to the attachment means, in order to provide access to the interior region of the module in which among others the actuator or motor driving the opening/closing mechanism are located.

In some embodiments of the first aspect, the actuator extends a relatively large distance from the rear portion of the front face of the module and into the interior space of the module. This makes shipping of the front face expensive, as each individual front face during shipping takes up a relatively large space. In an embodiment of the first aspect, the actuator and possibly additional drive means can hence be provided separately and mounted on site in the room in which the modules are to be used.

For modules that are to be attached to the ceiling of a room, mineral wool slabs functioning of the sound absorbing device can be mounted on a surface of for instance expanded metal/mesh, which is mounted onto the front face during production of the front face.

In order to make the closing mechanism close as acoustically tight as possible, a resilient part can be applied to various parts of the mechanism in order to absorb any tolerances, for instance on hinge members in the opening/closing mechanism.

### Second Aspect of the Present Invention

The second aspect of the present invention relates to a front face for use for instance in the modules according to the first aspect, where the front face is provided with a plurality of through-openings that—in an open state—provide access of sound energy to a sound absorbing device, as described above under the first aspect of the invention. The front face is provided with an opening/closing mechanism configured to open or close the through-openings provided in the front face. According to any of the aspects of the invention, the opening/closing mechanism is configured such that it can provide a substantively acoustically tight closing of the through-openings, i.e. it can very effectively prevent sound energy from passing through the through-openings in the closed state of the front face. It has been found to be very essential for the function of any of the aspects of the present invention that substantially no sound energy can pass through the through-openings and enter a sound absorbing device, when the front face is in its closed state.

In a preferred embodiment of the second aspect, the opening/closing mechanism is configured such that the outer surface of the front face that faces the external region or space in which it is required to vary the reverberation time is maintained plane or smooth in any state of the opening/closing mechanism, such that for instance a covering sheet can be attached to the outer surface (or in the vicinity hereof) without obstructing the opening/closing mechanism.

In an embodiment of the second aspect, the front face comprises a plurality of through-openings through which sound energy can pass, when the through-openings are in an open state, where the front face is provided with an opening/closing mechanism configured for opening and closing said through-openings, where the opening/closing mechanism comprises a closing member and a retaining mechanism, which retaining mechanism is configured such that it maintains the closing member in contact with substantively the entire circumference of the through-openings, when the module is in a closed state.

In an embodiment of the second aspect, the opening/closing mechanism is configured to obtain a substantially acoustically tight closing of said through-openings, where the mechanism comprises a first and a second closing face, where the mechanism is configured such that it closes the through openings, when the first and second closing faces are in contact with each other and opens the through openings, when the first and second contact faces are not in contact with each other.

In an embodiment of the second aspect, the at least one of the first or the second closing faces is provided with magnetic means configured to urge the first closing face against the second closing face, when the mechanism is brought into the closed state.

In an embodiment of the second aspect, the first closing face comprises a permanent magnetic material and the second closing face is made of a material that can be attracted by the magnetic material of the first closing face.

In an embodiment of the second aspect, the first contact face is provided with an electro magnet and the second contact face is made of a material that can be attracted by the electro magnet of the first contact face.

In an embodiment of the second aspect, the means for opening and/or closing comprises an actuator or motor means operatively connected to the means for opening and/or closing the through-openings, which actuator or motor means can be remote controlled by a user from a user interface.

In an embodiment of the second aspect, the opening/closing mechanism comprises a pivotally mounted plate member that is configured to pivot about a pivot axle in fixed relationship with the front face, such that the plate member can pivot between a closed state, where the plate member closes the through-opening in the front face and an open state, where the plate member does not close the through-opening, where the plate member is provided with said first closing face and the front plate on a corresponding portion is provided with said second closing face.

In an embodiment of the second aspect, the plate member pivot about a pivot axle in a direction towards the interior region or space of the module, when the module varies from a closed to an open state.

In an embodiment of the second aspect, one of the closing faces are provided with a permanent magnetic material, such as a magnetic ribbon, and the other closing face is made of a material that can be attracted by a magnetic force from the magnetic material provided on the opposing closing face.

In an embodiment of the second aspect, the first closing face at an edge portion hereof opposite said pivot axle is provided with resilient retaining means configured to maintain said second closing face in a fixed relationship to the first closing face.

In an embodiment of the second aspect, the opening/closing mechanism comprises a sliding plate member mounted for a sliding movement (B) substantially in parallel with the front face, such that the sliding plate member can move between a closed state, in which it closes the through opening in the front face and on open state, in which it does not close the through opening in the front face.

In an embodiment of the second aspect, the sliding plate member at opposing edge portions in the direction of movement (B) is provided with leg portions, such that the sliding plate member has a general U-shape, and where the front face is provided with corresponding leg portions at the edges of the through opening extending perpendicularly to the direction of movement (B) of the sliding plate member, such that one leg portion of the sliding plate member corresponds to one leg portion of the front plate and the other leg portion of the sliding plate member corresponds to the other leg portion of the front face, where the first leg portion of the sliding plate member in the closed state of the opening/closing mechanism is substantially in contact with the corresponding leg portion of the front face and the other leg portion of the sliding plate member is substantially in contact with the corresponding leg portion of the front face, whereby the through opening in the fornt face is substantially closed.

In an embodiment of the second aspect, one of the leg portions of the sliding plate member is provided with a magnetic material configured to urge said leg portion towards the corresponding leg portion on the front face and/or where the other leg portion is provided with a magnetic material configured to urge said other leg portion towards the corresponding other leg portion on the front face, when the opening/closing mechanism is brought into the closed state.

In an embodiment of the second aspect, the opening/closing mechanism comprises an opening/closing plate member extending substantially in perpendicular the front face and covering the through opening in the front face, such that an overlapping closing face is formed between the edge portions of the plate member and the corresponding edge regions of the front face adjacent to the through opening, where the opening/closing mechanism comprises actuator means connected to the plate member configured to move the plate member in a direction substantively perpendicular to the front face between a closed state, in which the plate member closes the through opening and an open state, in which the plate member does not close the through opening.

In an embodiment of the second aspect, the closing face at an edge portion hereof is provided with resilient retaining means configured to maintain said closing face in a fixed relationship to the front face.

In an embodiment of the second aspect, either the overlapping closing region or the corresponding edge regions or both of these regions/portions are provided with magnetic means, which magnetic means is configured to urge the overlapping closing region towards the corresponding edge region, when the opening/closing mechanism is in the closed state.

In an embodiment of the second aspect, the opening/closing means comprises actuator means configured to move the opening/closing mechanism between the open state and the closed state.

In an embodiment of the first aspect, the front face is curved.

### Third Aspect of the Present Invention

The third aspect of the present invention relates to a system comprising a plurality of modules according to the first aspect of the invention.

The above and further objects and advantages are according to a third aspect of the present invention provided by a system with variable acoustic properties configured for covering boundaries, such as walls or ceilings of a room, for instance a multi-purpose room, in which it must be possible to change the acoustical properties of the room, such as the reverberation time, according to each specific use, where the system comprises a plurality of modules M1, M2, . . . M10 according to the first aspect of the invention, where the individual modules M1, M2, . . . M10 are in communication with a control unit, such that the control unit can control the opening/closing of the through-openings in each individual module by controlling the corresponding opening/closing mechanisms of the individual modules.

In an embodiment of the third aspect, the system comprises a user interface functionally in communication with the control unit, whereby the reverberation time of the room in which the modules M1 through M10 are provided can be controlled by a user by opening/closing each individual of the modules.

In an embodiment of the third aspect, the system comprises an electronic memory in which corresponding settings (open/close state) of each individual module can be stored for instance together with a description of the kind of performance for which the obtained reverberation time is regarded as optimal.

In an embodiment of the third aspect, lightning means are provided in the through-openings, or inside the sound absorbing device, such that light emitted by these means can be seen from the room in which the system is installed, thereby to indicate the state of the individual modules used in the system.

In an embodiment of the third aspect, the front faces of modules or groups of modules extend at different distances from the boundary on which they are mounted or at different angles relative to the boundary. This can for instance be obtained by varying the depth of the frame structure/attachment means correspondingly. By using this embodiment of the second aspect, sound diffusion at mid and low frequencies can be obtained, if desired.

In case the modules only cover limited portions of a boundary it is important that the end and side faces of the outermost modules are covered by substantially sound impermeable panels or the like, such that sound access via the end and side faces of the attachment means of these modules into the interior region of the modules that contain the sound absorbing means is effectively prevented.

In an embodiment of the third aspect, the opening/closing mechanism is configured such that a single motor or actuator can drive a plurality of modules according to the first aspect.

In an embodiment of the third aspect, the opening/closing mechanism is configured such that it is possible to install the opening/closing mechanism before the front faces of the respective modules are installed. Thus, according to this embodiment, the opening/closing mechanism may form a part of the attachment structure or frame structure that is used to attach the front faces of the individual modules to a boundary of a room.

### Fourth Aspect of the Present Invention

The fourth aspect of the present invention relates to a system of front faces according to the second aspect of the invention. According to the fourth aspect, the sound absorbing device or devices are a part of the boundaries of a room in which the system according to the fourth aspect is to be installed. Thus, it is according to the fourth aspect only necessary to install a plurality of front faces according to the second aspect in an appropriate manner on the sound absorbing devices already present in the room.

In an embodiment of the fourth aspect, the sound absorbing device, such as bats of mineral wool, are pre-installed on chosen boundaries of a room. In this case, it is only necessary to install the front faces according to the second aspect of the invention on the chosen boundaries, such as wall (portions) and/or ceiling (portions) in the room in order to obtain the desired variability of at least the reverberation time that is provided by the present invention.

### Fifth Aspect of the Present Invention

The fifth aspect of the present invention relates to an opening/closing mechanism for use in the first, second, third and fourth aspect of the invention. In order to obtain the desired sound absorbing function of the invention, it is very essential that the opening/closing mechanism provides a very tight acoustic closing of the through-openings in the front face described above. The fourth aspect relates to means for obtaining this very tight acoustic closing.

According to the fifth aspect there is provided an opening/closing mechanism for providing a substantially sound-impermeable closing of a sound energy communication passage, the passage being configured to provide sound energy to a device providing variable acoustics, such as reverberation time, of for instance a room or hall, where the sound energy communication passage along substantially the entire circumference of a cross-section of the passage, through which cross section sound energy passes when the passage is in an open state, is provided with a first closing face, where the opening/closing mechanism comprises a closing member provided with a second closing face in overlapping relationship with the first closing face, such that when the first and second closing faces are brought substantially in contact with each other, the first and second closing faces close the passage, such that sound energy is substantively prevented from passing through the passage, where the opening/closes mechanism comprises closing member retaining means that substantially prevents the second closing face from moving relative to the first closing face when the passage is in the closed state.

In an embodiment of the fifth aspect, at least the first or the second closing face is provided with magnetic means configured to urge the first closing face against the second closing face, when the mechanism is brought into the closed state.

In an embodiment of the fifth aspect, the first closing face is provided with a permanent magnetic material and the second closing face is made of a material that can be attracted by the magnetic material of the first closing face.

In an embodiment of the fifth aspect, the second closing face is provided with a permanent magnetic material and the first closing face is made of a material that can be attracted by the magnetic material of the second closing face.

In an embodiment of the fifth aspect, both the first closing face and the second closing face are provided with a permanent magnetic material.

In an embodiment of the fifth aspect, at least one of the magnetic materials is an electro magnet.

### Sixth Aspect of the Present Invention

The sixth aspect of the invention relates to a method of using the first to fifth aspect of the invention to vary the reverberation time (RT) of a room according to the specific uses of the room.

According to the sixth aspect of the invention there is provided by a method for altering the reverberation time of a room, at least at low frequencies, without thereby changing the visual appearance of the room when the reverberation time is altered, the method comprising:
providing a plurality of modules according to the first aspect of the invention or a system according to the third aspect of the invention;
attaching the modules or system to one or more boundaries of the room;
varying the state (open/closed) of the individual modules or system of modules and determining the corresponding reverberation time of the room;
when a required reverberation time is obtained, maintaining the corresponding state (open/closed) of the individual modules.

In an embodiment of the sixth aspect, the method further comprises storing in memory means the determined settings of the individual modules corresponding to each specific use of the room.

The modules, system and method according to the present invention will make it possible to alter the reverberation time of a room or hall very significantly at low frequencies. This effect requires among others that the depth of the modules, i.e. the distance from the wall portion on which the modules are mounted to the front face of the sound absorbing material, is optimized, as a larger depth will result in the effect extending to lower frequencies. If amplified music (or speech) is rendered in a room or hall, this will require a relatively short reverberation time at low frequencies, which short reverberation time can be obtained by applying the modules, system and method of the invention. At higher frequencies, for instance above 1 kHz, the audience, empty chairs etc. in the hall will usually provide the sound absorption and scattering required to obtain a relatively low reverberation time at mid and high frequencies. Furthermore, loudspeaker systems used in live performances of pop or rock music will at mid and high frequencies have a directional characteristic that directs the major portion of sound energy at those frequencies towards the audience and not towards the boundaries of the hall. This also contributes to limiting the reverberation time at mid and high frequencies.

By the application of the modules, system and method according to the invention, the reverberation time of multi-purpose halls can be varied at least at low frequencies such that many different genres of performances can take place under optimal acoustic conditions, such as the presentation of movies, live performances of pop or rock music, chamber music, symphonic music, operas, choirs, theatrical performances and lectures.

By the application of a system according to the invention, it is possible to open some of the modules making up the system and closing others, thereby optimizing the reverberation time for a given purpose.

By the application of a system according to the invention, the variability of the reverberation time can be obtained without thereby changing the appearance of the room or hall.

### Seventh Aspect of the Present Invention

The seventh aspect of the present invention relates generally to the use of magnetic means for establishing a substantially sound-impenetrable closing of an opening/closing mechanism configured for use in devices and systems that provide variable acoustical characteristics in rooms, such as variable sound absorption, sound reflection and reverberation time (RT).

### An Important Feature of the Opening/Closing Mechanism of the Invention

One feature of preferred but not limiting embodiments of the opening/closing mechanisms according to any of the aspects of the present invention is that the opening/closing members used to open and close the access of sound energy through the through-openings in the front plate is configured such that it never extends beyond the front surface of the front face, whereby the front surface in any state of the opening/closing mechanism remains smooth and un-broken by the opening/closing members, such that it becomes possible to attach a covering sheet directly (or in close proximity) to the front surface.

### Advantages and Effects Provided by the Present Invention

By the application of a system according to the invention, it becomes possible to store the settings of different modules corresponding to the optimal reverberation time for different applications of the room or hall.

By the application of the modules, system and method according to the invention, the reverberation time of the room or hall without the presence of the modules or system according to the invention can be relatively long. Thereby it becomes possible after the initial design of the room or hall to install the modules or system according to the invention to provide the variability required in order to make the room or hall suitable for different purposes that require shorter reverberation times.

The fact that the system according to the invention can present large uniform or unbroken surfaces of any finish and appearance to the public in the room or hall makes it possible by the application of the system according to the invention, it becomes possible to install large enough areas of variable acoustic means to obtain the desired span of reverberation time (RT) since these variable acoustic means will not be visually compromising the overall interior design and further to apply visual effects (colored light, pictures, video sequences, etc.) on these unbroken surfaces, thereby varying the appearance of the room or hall according to different applications and/or providing information relating to the actual use of the room or hall directly on the unbroken surface portions of the system according to the invention.

The various aspects of the present invention described below solve several key challenges, of which the following three are mentioned:
1) Application of the various aspects of the present invention provides a large span in reverberation time (RT) of a room in which the invention is used. Thus, RT can easily be doubled (or halved) by application of the invention, a magnitude of variation that has never been achieved before. This has become possible due to two factors referring to Sabines formula: (1) Modules, units or entire systems according to the invention can be mounted both in the very large ceiling area of a room as well as on wall areas and (2) delta alpha is large, typically 0.6-0.8 in the important low-frequency bands.
2) The RT at low frequencies is varied whereas high frequencies for instance above 1000 Hz are not affected to the same extend by the application of the present invention. This is particularly advantageous according to recent research [2] and NS 817, and has previously only been achieved in the inventor's previous invention as described in EP 1779375, U.S. Pat. No. 7,905,323 and JP 4782193.
3) The acoustic variability obtained using the present invention does not affect the visual appearance of a room in which the invention is installed, which will yield application of the invention attractive both from the point of view of audiences and of for instance architects or others responsible for the interior design of a room, for instance a multi-purpose hall. The variable sound absorbing devices used in the present invention can be embedded in the interior design and the sound absorbing devices can hardly be seen. This has never been achieved before to this extend.
4)

### System Configurations

It is well known within architectural acoustics, that when absorption is scattered as much as possible in the room or auditoria, this will create a sound field with an energy density, which is as uniform as possible resulting in a sound decay that sounds beautiful to the human ear. In order to achieve the sought-after variability of a doubling or halving of RT with the present invention, a typical situation could be to fill most of the ceiling area as well as some wall areas with the panels.

Example: In a 6000 m³ hall with dimensions L×W×H=30 m×20 m×10 m it should be possible to vary RT from 1.1 sec. to 2.2 sec. according to the formerly mentioned NS 8178. A Sabine calculation yields, that this would require app. 700 m² of modules according to the present invention to obtain this variation of RT in the 125 Hz octave band with a Δα of 0.6. The ceiling area accounts for instance for 600 m² so that 100 m² wall area should also be used.

In order to achieve a more uniform sound energy density, the modules could be scattered more, for instance with more area on the walls and less in the ceiling. This will also comply better with Sabine's formula, which assumes a perfectly diffuse room, With a module size of 2.4 m×0.6 m a total of approximately 486 modules must be used to cover the needed 700 m². In order to make ideal reverberation time conditions not only for pop music (1.1 sec.) and chamber music (2.2 sec.) but also for instance for loud acoustic music such as brass bands (1.7 sec.) it should be considered which modules or units according to the invention should be turned ON respectively OFF in such middle-configurations. This would be up to the acoustic engineer on the job to decide, and one path to pursue could be to scatter the absorptive panels (ON) as much as possible in order to create a beautiful sound. But also, practicality when mounting the modules must be considered here. A typical installation will consist of N rows of modules with M modules in each row. In the above example, the width of the hall and thus the ceiling is 20 m. This would allow up to 20/0.6=>33 rows across the ceiling if each module is 60 cm wide. One configuration would be all 33 rows ON (pop music), another all rows OFF (chamber music) while a third could be every second row ON etc. A number of presets would be made available for the hall to choose from for each concert according to genre of performance. However, in reality some areas in the ceiling will be not used for acoustic variability but for utility purposes such as ventilation, sprinklers, lighting, service hatch for the variable acoustic modules etc.

Further, the amount of sound absorption at the end portion of a hall (the stage area) where an orchestra is situated, the stage area can according to the invention be adapted for various kinds of performances. This also applies for the other portions of the hall, where an audience is situated. This will make it possible by application of the invention to control the amount of early and late sound energy to the musicians and can for instance ensure that the total sound level, especially experienced by the musicians, is not so large that is may harm the musician's hearing.

### BRIEF DESCRIPTION OF THE DRAWINGS

Further benefits and advantages of the present invention will become apparent after reading the detailed description of non-limiting exemplary embodiments of the invention in conjunction with the accompanying drawings, wherein

FIG. 1 shows a schematic perspective view of a system according to an embodiment of the invention as well as a covering sheet;

FIG. 2 shows a schematic cross-sectional representation of a module according to an embodiment of the invention attached to a wall or ceiling portion of a room, where the module is provided with a sound absorbing device consisting of a bat of for instance mineral wool;

FIGS. 3(a) and 3(b) show an embodiment of an open/close mechanism for the modules according to the present invention;

FIG. 4 shows a schematic detailed view of the module according to the embodiment of the invention shown in FIGS. 3(a) and 3(b) in the closed state;

FIG. 5 shows a schematic representation of a system according to an embodiment of the invention, which system is provided with a user-operable control unit,

FIG. 6 shows a schematic perspective view of a system according to an embodiment of the invention seen from the side of the system opposite to the front face, i.e. the side of the system that faces the boundary on which it will be mounted;

FIG. 7 shows a schematic perspective view of a system according to an embodiment of the invention seen from a direction towards the front face, i.e. the side of the system that faces away from the boundary on which it will be mounted;

FIGS. 8(a) and (b) shows an example of a sound absorption coefficient measured in ⅓-octave bands obtained with an embodiment of a module according to the invention in the open and closed state, respectively;

FIG. 9 shows an embodiment of a system with covering sheets according to the invention covering portions of two boundaries of a room;

FIG. 10 shows examples of two alternative shapes of the modules according to the invention;

FIG. 11 shows a schematic representation of a first embodiment of an opening/closing mechanism according to the invention;

FIGS. 12(a) and (b) show a schematic representation of a second embodiment of an opening/closing mechanism according to the invention;

FIG. 13 shows a schematic representation of a third embodiment of an opening/closing mechanism according to the invention;

FIG. 14 shows a schematic representation of a fourth embodiment of an opening/closing mechanism according to the invention;

FIG. 15 is a perspective view of an example of a practical implementation of a module according to the invention showing an embodiment of an opening/closing mechanism on the rear side of the front face according to an embodiment of the invention;

FIG. 16 is a plane view of an example of a practical implementation of the front face of a module according to an embodiment of the invention showing a pattern of through-openings provided in the front face;

FIG. 17 is a perspective view of an example of a practical implementation of a portion of an embodiment of a module according to the invention and an attachment structure for attaching the module to a boundary, such as a ceiling, of a room;

FIG. 18 is a perspective view of an example of a practical implementation of an embodiment of a module according to the invention and an attachment structure for attaching the module to a boundary, such as a ceiling, of a room, where the module is provided with sound absorbing bats placed behind the through-openings in the front face of the module;

FIG. 19 is a schematic perspective partly exploded view of an embodiment of a module according to the invention in which the side faces of the module are closed by plate elements;

FIG. 20 is a photo showing a practical implementation of an opening/closing mechanism according to the first embodiment shown in FIG. 11 seen from the rear side of the front face;

FIG. 21 is a photo of a module according to an embodiment of the invention seen from the rear side of the front face showing one practical implementation in which the edge portions of the through-openings in the front face are all provided with a magnetic ribbon;

FIG. 22 is an illustrative representation of an opening/closing mechanism according to an embodiment of the invention;

FIG. 23 is a schematic representation of a fourth embodiment of an opening/closing mechanism according to the invention;

FIG. 24(b) is a schematic illustration of two adjacent modules of the type shown in FIG. 24(a) functionally connected such that they can be operated by a single actuator as for instance shown in FIG. 21(a);

FIG. 25 shows an alternative embodiment of magnetic means used to provide an acoustically tight closing of the opening/closing mechanism of the front faces of the invention; and

FIG. 26 is a plot of the sound reduction index of a 2 mm thick steel plate with a mass per unit area of 16 kg/m² that as an example can be used to form the front face and the closing plates used the present invention.

### DETAILED DESCRIPTION OF THE INVENTION

The principles of the invention will be illustrated by various embodiments hereof. It is however understood that a person skilled in the art may conceive other embodiments than those actually shown and described in the detailed description of the invention and that the scope of the invention is defined by the independent claims.

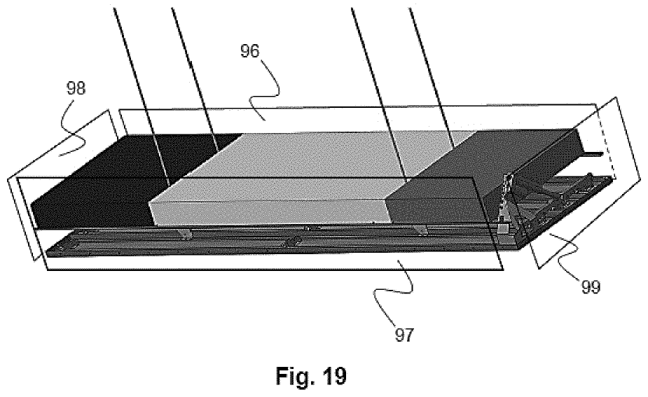

In order to clarify the terminology used in the following, a “module” is an entity that comprises a front face (with associated opening/closing mechanism) and a sound absorbing device or means, as for instance a sound absorbing bat. A module may in some embodiments further comprise a frame structure, that can be used for instance to attach the sound absorbing device or means to the other parts of the module or that may as an option be used to attach the module to a boundary. The frame structure may also be used to provide the module with side faces and a rear face supported by the frame structure, which side and rear faces largely prevent sound energy from reaching the sound absorbing device or means through these faces. An exemplary embodiment of a module is shown in FIG. 18 and the above-mentioned side and rear faces are illustrated in FIG. 19.

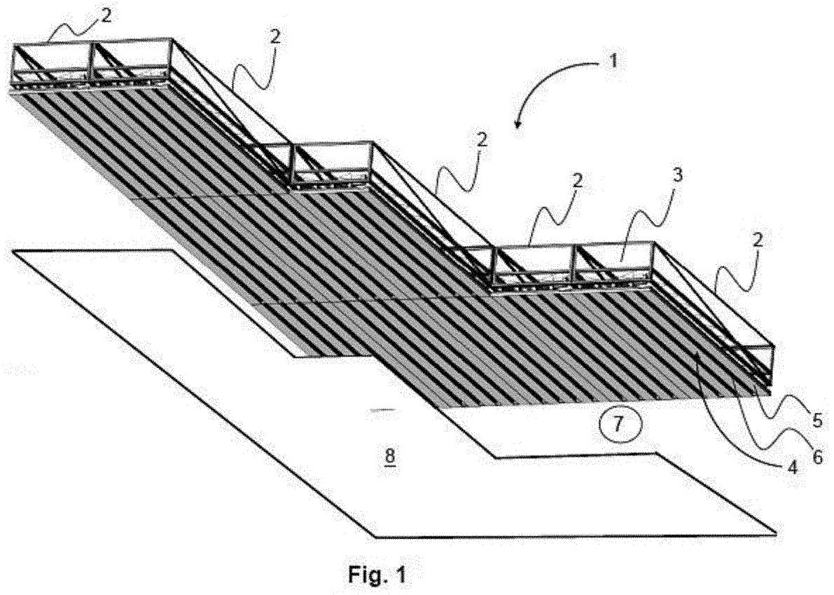

With reference to FIG. 1 there is illustrated the basic concept of the invention by means of a schematic perspective view of an embodiment of a system according to the second aspect of the invention.

The system shown in FIG. 1, generally designated by reference numeral 1, comprises 10 modules according to the first aspect of the invention. These modules are in use mounted on one or more boundaries of a room by suitable attachment means 2. The modules comprise a front face generally designated by reference numeral 4, which front face in the shown embodiment comprises a number of longitudinally extending slats 5, where an opening 6 is provided longitudinally between adjacent slats 5. These through-openings 6 provide access from the exterior region 7 outside the modules to an interior region 3 inside the modules. The through-openings 6 allow sound energy to pass from the exterior region 7 to the interior region 3, when the through-openings are in an open state. Inside each module there is provided means configured to close the through-openings 6, such that sound energy cannot pass from the exterior region 7 to the interior region 3. These opening/closing means will be described by way of non-limiting examples in the following.

According to the invention, a covering sheet 8 of a material and construction that makes it possible for sound energy to enter the interior region 3 via the region 7 through the covering sheet 8 and the through-openings 6, when the through-openings 6 are in an open state, can be attached to the front faces 4 of modules that form a system (in the shown example the ten modules). Thus, a seemingly unbroken surface 8 can be brought to cover the modules of the system, such that the individual modules cannot be seen by persons in the room in which the modules are installed.

More than a single sheet may be used according to the invention. Thus, a sheet may consist of a number of individual sheets or portions. Thus, for instance in a practical installation, a sheet may be dimensioned to cover five single modules in a row (i.e. the sheet has one dimension corresponding to the height of a module). A sheet may also comprise elongated panels extending longitudinally over all or some of the slats of individual modules.

The sheet 8 is in an embodiment of the invention made of veneer that is provided with perforations, at least in the regions of the veneer that cover the through-openings 6 in the front faces 4 of the modules. The veneer can, if necessary, be attached to an intermediate sheet or panel of for instance gypsum board material or fiber cement board material that is provided between the front faces 4 and the veneer 6. In order for the system to function acoustically optimal, the airflow resistance of the perforation and the intermediate sheet must be as low as possible.

The modules and the manner in which the modules and system according to the invention can alter the reverberation time of the room in which the modules or system is provided will be described in the following.

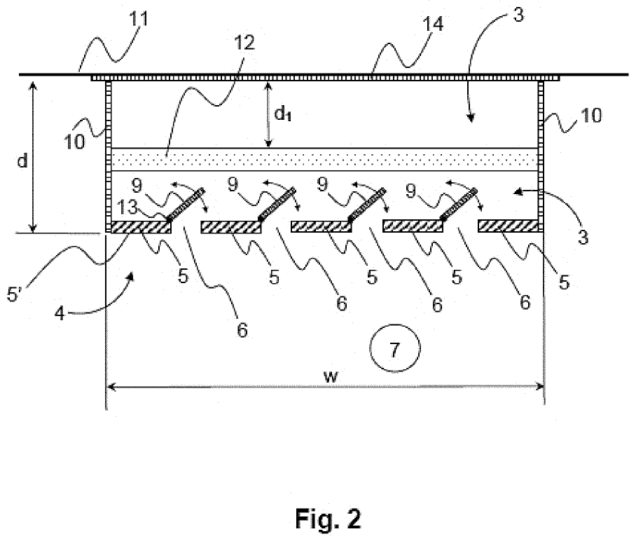

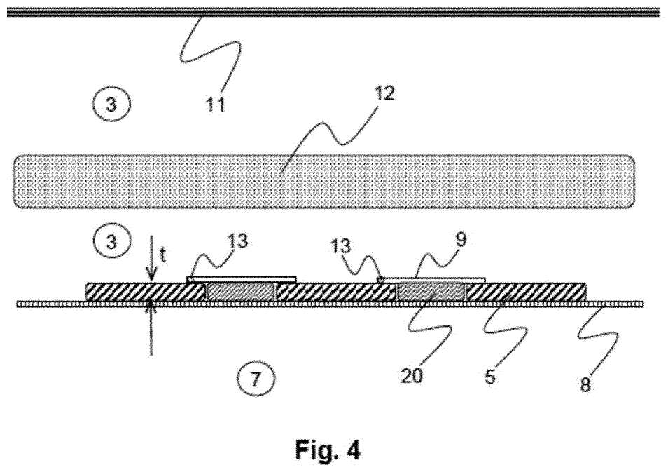

With reference to FIG. 2 there is shown a schematic cross-sectional representation of a module according to an embodiment of the invention. The module is mounted on a boundary 11 of a room, such as a wall or a ceiling. The module comprises a front face 4 comprising slats 5 and through-openings 6 provided between adjacent slats (it is understood that the portions of the front face here referred to as slats could alternatively be portions of the front face itself with through-openings provided between these portions as for instance shown in FIG. 16). The through-openings 6 can be closed by means of plates 9 or other suitable closing/opening members that are pivotally attached by hinges 13 as indicated in FIGS. 2 and 4. Since the plates 9 open inwards, the sheet 8 (see FIG. 1) can be mounted flush to the front face 4.

As it also appears from FIG. 1, the modules according to this embodiment comprises a frame structure (shown by reference numerals 10 and 14 in FIG. 2) that comprises side posts 10 and lateral posts 14. In FIG. 2, the module is attached to a wall portion 11 via the lateral posts 14. The frame structure of the module creates an inner space 3. In this inner space 3 there is provided a sound absorbing device, which in the shown embodiment consists of a sound absorbing material 12. In the shown embodiment, the sound absorbing material consists of a plate or slab or bat that extends laterally and longitudinally (i.e. in the direction perpendicular to the plane of the figure) over the entire width w of the module, but the sound absorbing material could alternatively fill the entire inner space 3 up to the lateral posts 14. The sound absorbing material can for instance consist of a combination of mineral wool, for instance a slab of a thickness of 10 cm, and a region of air, with a thickness d1 of a suitable value, such as for instance 25 cm. It is also possible to include a membrane absorber in the interior space 3 in order in increase absorption at low frequencies with a smaller distance d₁ to save space. The slab 12 of mineral wool must be provided at a distance from the wall 11 that yield maximum sound absorption, i.e. in a region in the interior space 3 in which the particle velocity of the sound field created in the interior space 3 is as large as possible.

It is important that sound energy from the surroundings can only enter the inner space 3 via the through-openings 6 such that sound absorption is only achieved, when the through-openings are in an open state. This can be achieved (as shown schematically in FIG. 19) by providing the frame structure 10 with panels (reference numerals 96, 97, 98 and 99 in FIG. 19) that acoustically shield off the inner space 3 from the surroundings. Such panels can be applied to the single modules or to groups comprising a plurality of modules as desired. The frame structure 14 may also be provided with a covering panel, if this is deemed necessary to ensure that sound energy cannot reach the inner region 3 via the frame structure that is attached to the boundary 11.

In case a mineral wool is used, it is mandatory to wrap this in a bag or hose that prevents the mineral wool fibers to spread. The material of the hose must, like all other elements in the modules and system according to the invention comply with the B,S1-d0 fire standard (or other fire standards depending on the country in which they are used) and still be porous for air flow.

It is recommended that the distance from the wall portion 11 to the sound absorbing material be at least 10 cm in order to obtain a large absorption coefficient at low frequencies.

When mounted on a boundary (such as a wall or a ceiling), the modules must define an outer surface towards the room in which the modules are mounted that is substantially acoustically tight when the modules are in the closed state. Hence, it is essential that the opening/closing mechanism provides as close a seal to the adjacent portions of the slats as absolutely possible. Likewise, the connection between adjacent modules must be as acoustically tight as possible. Otherwise, sound energy will pass through small slits or openings between adjacent modules even though the through-openings 6 are acoustically tightly closed.

The slats 5 are preferably made of a material that ensures a surface weight of not less than 15 kg/m² in order to obtain a low absorption value even at low frequencies in the closed state of the through-openings 6, i.e. a high degree of sound reflection even at low frequencies in the closed state. Preferably, a sound absorption coefficient of less than 0.2 should be obtained at 125 Hz octave band.

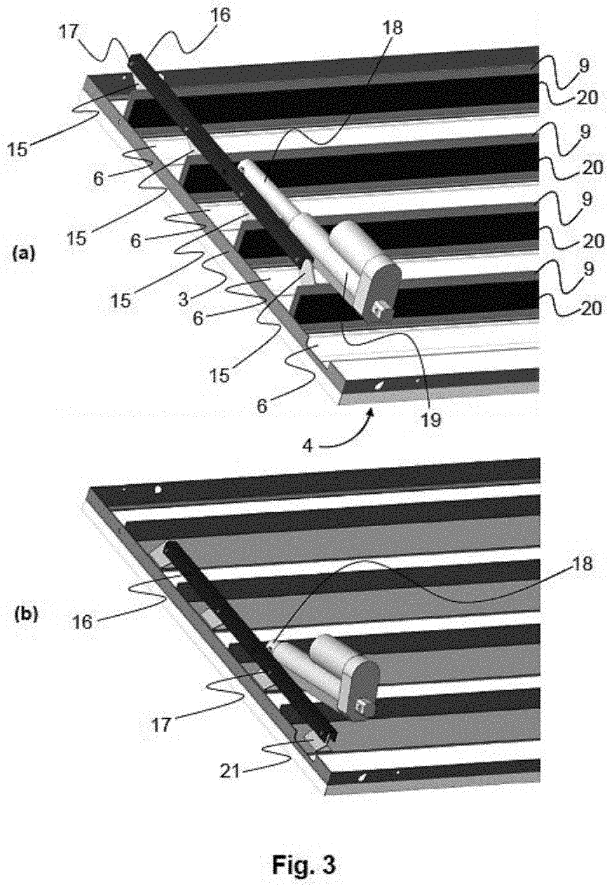

With reference to FIGS. 3(a) and 3(b) there is shown an embodiment of an opening/closing mechanism for the rear of the front face of the modules according to the present invention.

Thus, FIG. 3(a) shows a schematic view of the rear of the front face 4 of the module. In the front face 4 there are provided the through-openings 6 as described above. The plates 9 are pivotally connected to the front face frame 3 of the module such that the plates 9 can pivot between an open state (as shown in FIG. 3(a)) and a closed state (as shown in FIG. 3(b)). To each of the plates 9 there is attached a connecting member 15 that connects the rear surface of the plates 9 with a bar 16 that is pivotally connected to each respective of the connecting members 15. The actuator arm 18 of a linear actuator 19 is pivotally connected to the bar 16. When the actuator arm 18 is in the extended state as shown in FIG. 3(a), the plates 9 are in the open state, whereas, when the actuator arm 18 retracts into the position shown in FIG. 3(b) the plates 9 are pivoted about their respective hinge means and brought to the closed state, in which the plates 9 close the respective through-openings 6 in the front face 4. A substantially acoustically tight closing can be obtained for instance by providing a magnetic tape on the rear portions of the slats in the contact regions between the closing plates 9 and the rear portion of the slats. The application of a magnetic material to ensure a substantively acoustically tight closing will be described in more detail in the following. The actuator could for instance be an electric actuator or solenoid that can be controlled by providing it with electric current from a control unit under the control of for instance an operator.

On the surface of the plates 9 there can be provided insulating strips 20 of for instance a soft plastic material. The size of these strips 20 may correspond to the size of the corresponding through-openings 6 and have a thickness such that they extend at least entirely through the through-openings 6 in the closed state of the mechanism. By these means, the unwanted, permanent absorption from the perforated sheet 8 in front of the through-openings 6 can be significantly reduced when the mechanism is in the closed state.

With reference to FIG. 4 there is shown a schematic detailed view of the module according to the embodiment of the invention shown in FIG. 3 in the closed state. FIG. 4 shows the wall portion 11 to which the module is attached and a slab 12 of sound absorbing material provided in the interior space 3 of the module. Three of the slats 5 in the front face of the module are shown and the through-openings 6 (c.f. FIG. 3) between adjacent slats 5 are closed by the plates 9 as shown. On the outer surface (facing towards the outer region 7) there is provided soft plastic or similar strips 20 that substantially fill the opening 6 between the respective slats 5. On the front face of the module, the perforated sheet 8 is provided (or a sheet with perforations at least in the regions corresponding the through-openings 6 in the front face. In the shown embodiment, the strips 20 extend from the outer surface of the plates 9 to the inner surface of the perforated sheet, thus minimizing absorption from the perforated sheet in the regions hereof overlying the through-openings 6.

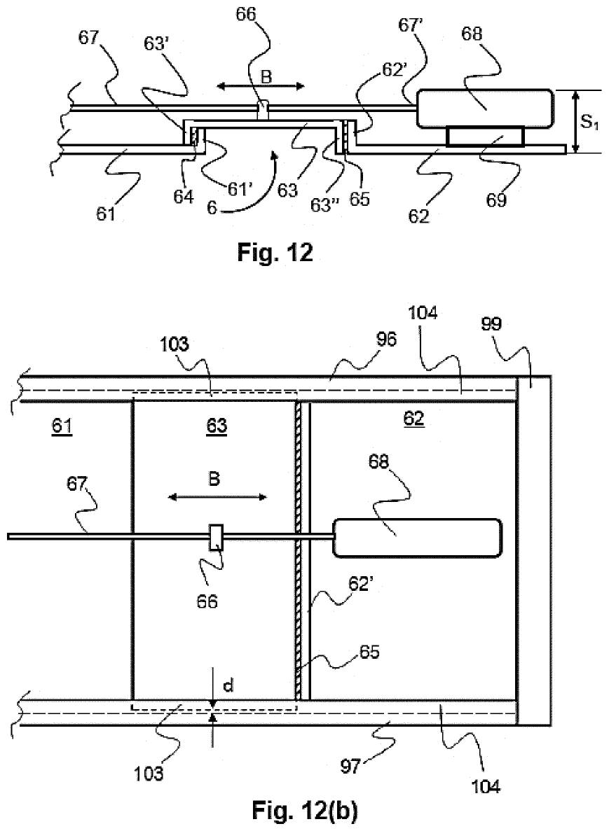

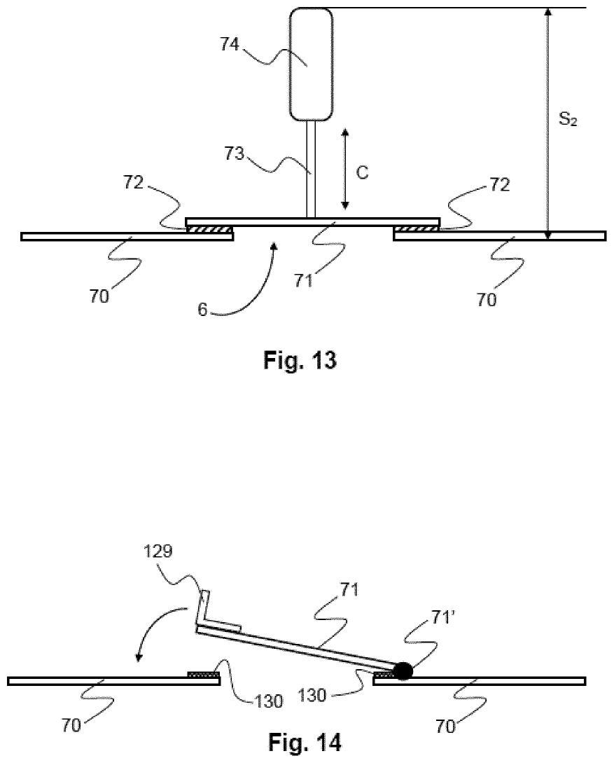

As an alternative to the opening/closing mechanism shown in FIGS. 3(a) and 3(b) a number of alternative mechanisms may be used. In one such alternative embodiment, the opening/closing plates 9 is mounted such that they can undergo a sliding movement on the inner surface of the front face between an open and a closed state. This will also enable for a covering sheet to be placed flush to the outer surface of the front face. This opening/closing mechanism can also be operated by means of an actuator arrangement substantially similar to the one shown in FIGS. 3(a) and 3(b). Some examples of alternative opening/closing mechanisms are shown in FIGS. 12 and 13 and will be described in more detail in the following.

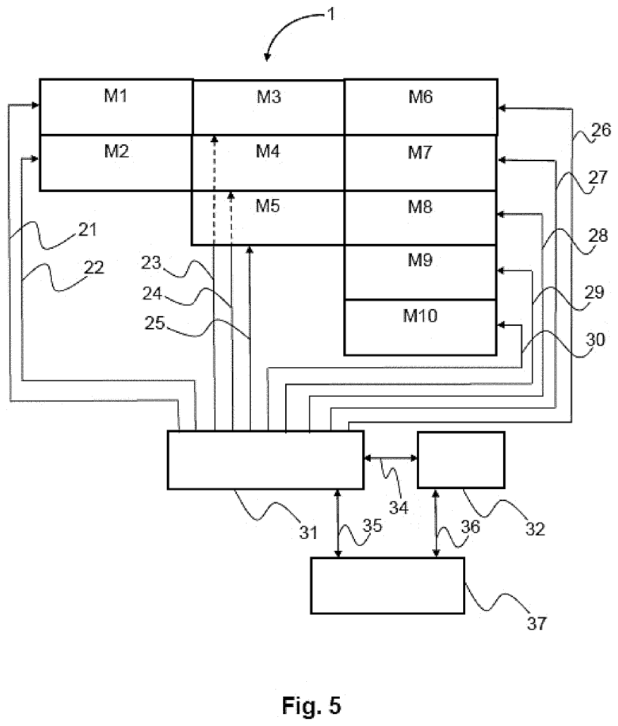

With reference to FIG. 5 there is shown a schematic representation of a system according to an embodiment of the invention, which system is provided with a user-operable control unit.

The system 1 shown in FIG. 5 comprises modules M1 through M10 according to the first aspect of the invention in a setup similar to the one shown in FIG. 1. Each individual module M1 through M10 is connected to a central control unit 31 via lines 21 through 30, such that the central control unit can control the opening/closing of the through-openings 6 in each individual module as explained above. A user can communicate with the control unit 31 via a suitable user interface 32 that is functionally connected to the control unit 31 via a line 34, and thereby control the reverberation time of the room in which the modules M1 through M10 are provided. When a suitable reverberation time has been obtained, the corresponding settings (open/close state) of each individual module can be stored in an electronic memory 37 together with a description of the kind of performance for which the obtained reverberation is regarded as optimal. The electronic memory 37 can cooperate with the control unit 31 and user interface 32 via lines 35 and 36, respectively.

Using the modules according to the first aspect of the present invention to form a system comprising a plurality of such controllable modules (as exemplified by the system in FIG. 5) makes it possible to vary the reverberation time RT of a room in which the system is installed within wide limits. Thus, embedding the plurality of modules forming a system in which the sound absorption coefficient α of the individual modules can be varied between a very high a value (up to close to unity at low frequencies) and a very low a value (down to below 0.2 through the entire audible frequency range of interest for live performances) gives the possibility to reach enough acoustic variability to achieve optimum acoustic conditions for a wide span of musical genres. As an example, a hall of 8000 m3 needs RT variability from 1.2 seconds (for pop and rock music) at low frequencies to 2.4 seconds for choir or small acoustic groups such as chamber music ensembles. Using Sabines formula for RT, this variability factor of 2 requires a large sound absorption area as well as a large variability of sound absorption coefficient α at mid and low frequencies (in the present context the difference between a in the open and closed state of the modules). Reference is made to NS 8178 (Norwegian Standard, “Acoustic criteria for rooms and spaces for music rehearsal and performance”). For other types of live performances—as well as for the use of the room as an auditorium, a theater hall or a cinema), reverberation times between the 1.2 and 2.4 seconds may be optimal. Such intermediate reverberation times can be obtained according to the invention by closing some of the modules forming the system and opening the other modules of the system. Using the system according to the invention, it hence becomes possible for an operator to choose the opening/closing state of the individual modules or groupings of modules forming the system to obtain the optimum reverberation time for a specific type of application of the room. It further becomes possible, once an optimal choice of open and closed modules has been found to store information regarding this optimal choice (for instance a record comprising the specific application situation and the opening/closing state of each individual module in the system) in the memory 37 for later use in similar cases.

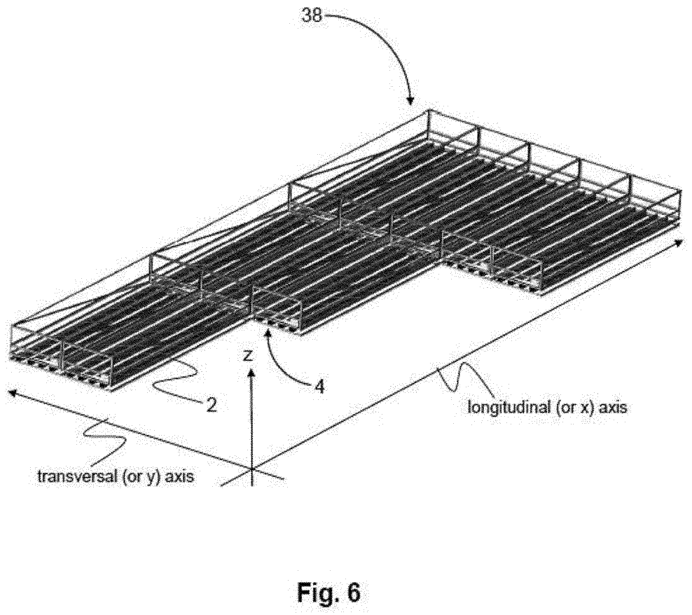

With reference to FIG. 6 there is shown a schematic perspective view of a system generally indicated by reference numeral 38 according to an embodiment of the invention as seen from the side of the system opposite to the front face 4 of the modules in the system, i.e. the side of the system 38 that faces the boundary of the room or hall on which it will be mounted. Each module is indicated by reference numeral 2. The system shown in FIG. 6 comprises 10 modules and corresponds to that shown in FIG. 1, except for the omission of the sheet 8 shown in FIG. 1. For clarity of the description, the terms “longitudinal” and “transversal” are defined by their corresponding axes in the figure. The depth or thickness of the system/modules are their extension in the direction of the z-axis.

With reference to FIG. 7 there is shown a schematic perspective view of a system according to an embodiment of the invention seen from a direction towards the front face, i.e. the side of the system that faces away from the boundary on which it will be mounted. The system comprises in this example embodiment (as in FIGS. 1 and 6) 10 modules with the front faces comprising elongated slats 5 provided with elongated through-openings 6 between adjacent slats 5 of each individual module. For each module, the frame structure comprises opposite end portion 39 and opposite side portion 40 that together with the front face and the boundary upon which the modules are mounted defines an inner region of the module in which a sound absorbing device, such as a slab of sound absorbing material, is provided. As mentioned above, the end portions and side portions 39, 40 that describe the circumference of a grouping of modules must be provided with panels preventing sound access from the surroundings to the sound absorbing material in the inner space of the modules through the end and side portions 39, 40.

With the embodiment of modules shown in FIG. 7, the adjacent lateral slats of two adjacent modules appear visually as a single slat of the double width as indicated at 41 in FIG. 7. When the system is not covered by a covering sheet 8 (as shown in FIG. 1), the total surface formed by the front faces of the individual slats 5 is hence not visually uniform. A visually uniform surface of the system can be obtained by means of the covering sheet 8, but it is also possible as an alternative to provide a visually uniform outer surface by providing each module with a pattern of slats and through-openings in which a slat extends along one longitudinal edge portion of a module and an opening extends along the opposite longitudinal edge portion of the module.

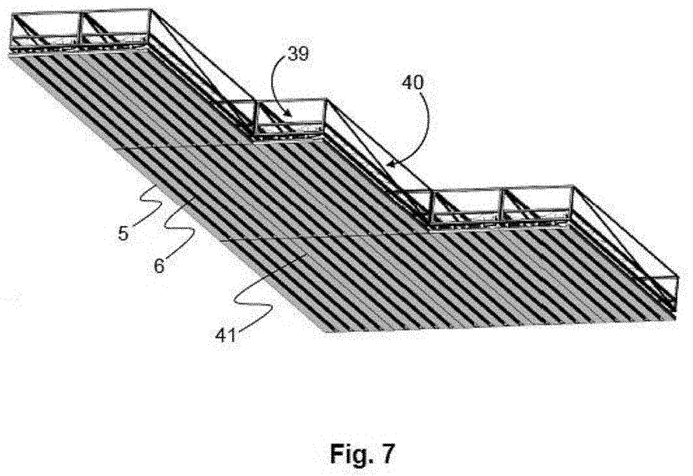

With reference to FIGS. 8(a) and (b) there is shown an example of a sound absorption coefficient as a function of frequency obtained with an embodiment of a module according to the invention. FIG. 8(a) shows ⅓-octave measurements of sound absorption coefficient in the open state of the module and FIG. 8(b) shows ⅓-octave measurements of sound absorption coefficient in the closed state of the module. It clearly appears that a very high sound absorption coefficient can be obtained with the modules/system according to the invention in the open state in the mid and low frequency range. Also, it appears that the sound absorption coefficient can be kept at a desired lower level at higher frequencies.

The measurements shown in FIGS. 8(a) and (b) were carried out in a reverberation room according to the test method EN ISO 354:2003. The certified report is available.

A low sound absorption coefficient value in the closed state of the modules results from a combination of a sufficiently heavy front face/closing plates and a sufficiently acoustically tight closing of the closing means as obtained according to the invention with the application of the described retaining means, such as the magnetic strips provided along substantively the entire circumference of the through-openings in the front face. The shown measurements relate to a module with a front face and closing plates made of steel with a thickness of 2 mm together with a magnetic tape (practically without resiliency) applied along substantially the entire circumference of the through openings. The mass per unit area of a 2 mm thick steel plate is approximately 16 kg/m².

The sound absorbing device is in this case a bat of 10 cm thick mineral wool placed as close to the rear side of the front face as possible in a construction that is 40 cm deep in total from front face to boundary. The sound absorption coefficient in the open state of the module can be increased from the 125 Hz octave and downwards by increasing the distance from the bat to the boundary (such as a wall or ceiling) behind/above the module.

A variation Δα of the sound absorption coefficient at 125 Hz and 250 Hz must be at least 0.5 between to open state of the module and the closed state of the module in order to be able to obtain the required variation of the reverberation time of the room.

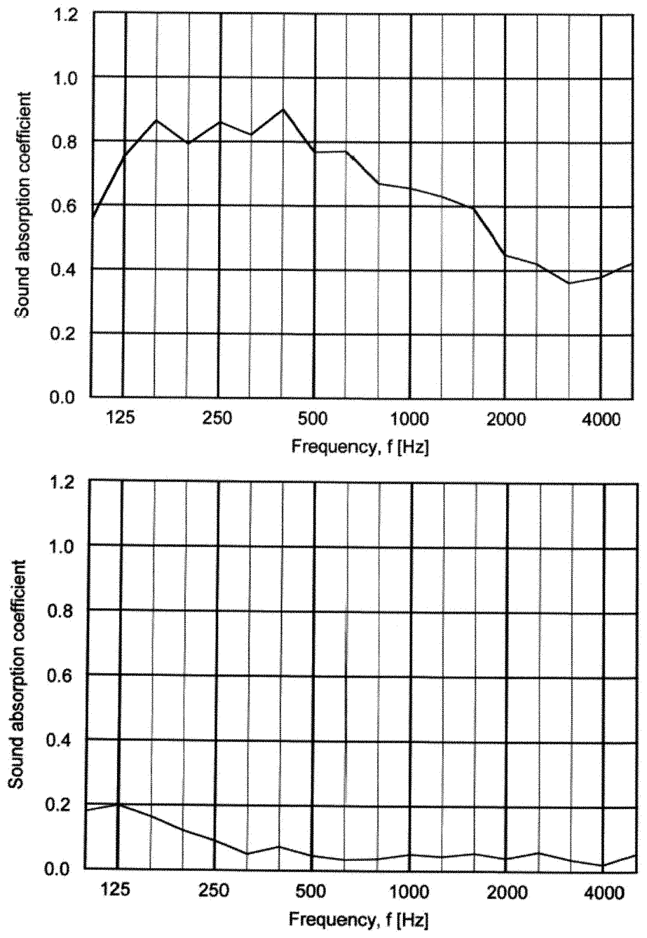

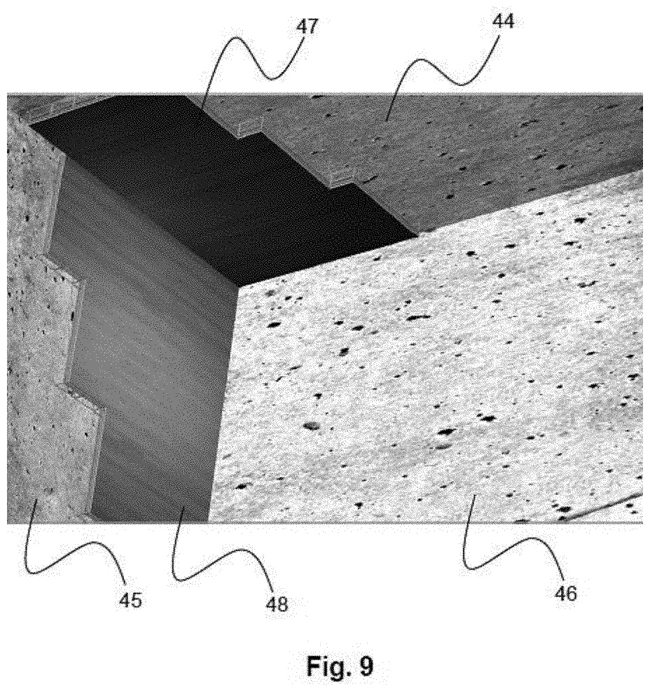

With reference to FIG. 9 there is shown an embodiment of a system according to the invention covering portions of two boundaries 44 and 45 of a room wherein a third boundary 46 is not provided with modules. The system of modules presents uniform surfaces 47 and 48 to a viewer located in the room. As seen, the front faces of the modules have been covered by sheets of a veneer type finish.

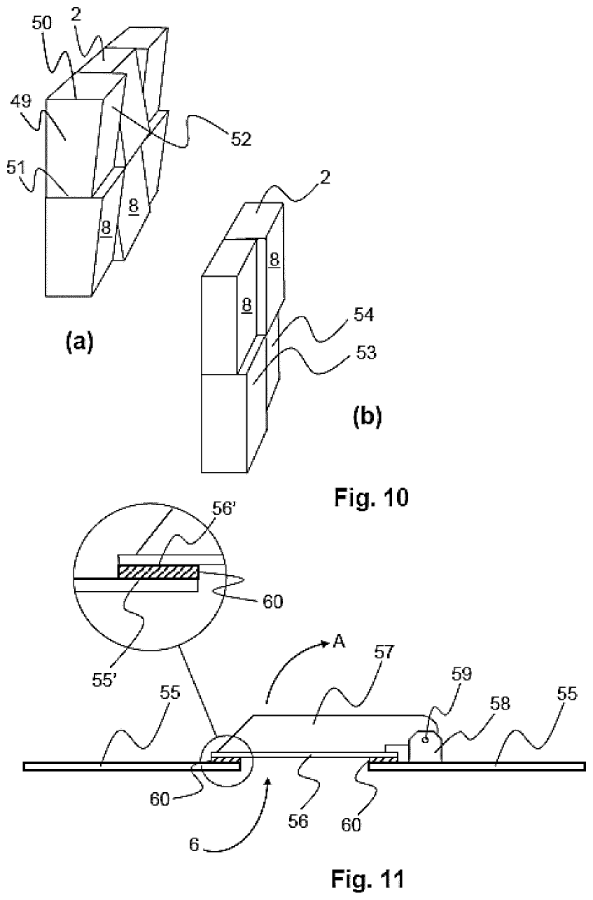

With reference to FIGS. 10(a) and 10(b) there are shown examples of two alternative shapes of the modules according to the invention.

FIG. 10(a) shows six modules 2 where a first 50 and a second 51 edge portion of a side portion 49 of a module have different length, such that the front sheet 8 of a module is inclined relative to a boundary on which the module is mounted. By using such modules, the design shown in FIG. 10(a) can be obtained in which the front sheets 8 of different modules incline in different directions. By using this design, a sound diffusion effect of a system of modules can be obtained, if desired, when the modules are in their closed state, in which they do not absorb sound energy. An alternative to the design shown in FIG. 10(a) is shown in FIG. 10(b) in which the modules have different depths such that the front sheets 8 of different modules are located at different distances from the boundary on which the modules are mounted. This design will also have a sound diffusing effect when the modules are in their closed states. Each of the individual modules forming the configurations shown in FIGS. 10(a) and (b) are provided with sound impermeable panels on the side, top and bottom faces (and possibly on the rear face opposite the front face in order to ensure that sound energy from the surroundings can only enter the interior space of the respective modules via the through-openings in the front face, when the respective module is in its open state.

As mentioned above it is very important that the opening/closing mechanism of the through-openings 6 in the front face leading from the surroundings to the sound absorbing device in the module can provide a substantially acoustically tight closing of the through-openings when the module is in the closed state. According to the invention, this can be accomplished by means of a magnetic closing mechanism, of which exemplary and non-limiting embodiments will be described in the following.

With reference to FIG. 11 there is shown a schematic representation of a first embodiment of an opening/closing mechanism according to the invention. A portion of a front face 55 is in the closed state closed by a plate member 56 that is provided on a pivot arm 57 that can pivot about an axle 59 of an attachment member 58 secured to one of the portions of the front face. The pivotal movement is indicated by arrow A in FIG. 11. Either on the plate member 56 or on the corresponding edge portions of the front face facing the plate member 56 there is provided a magnetic material 60, for instance by applying a magnetic ribbon on these portions.

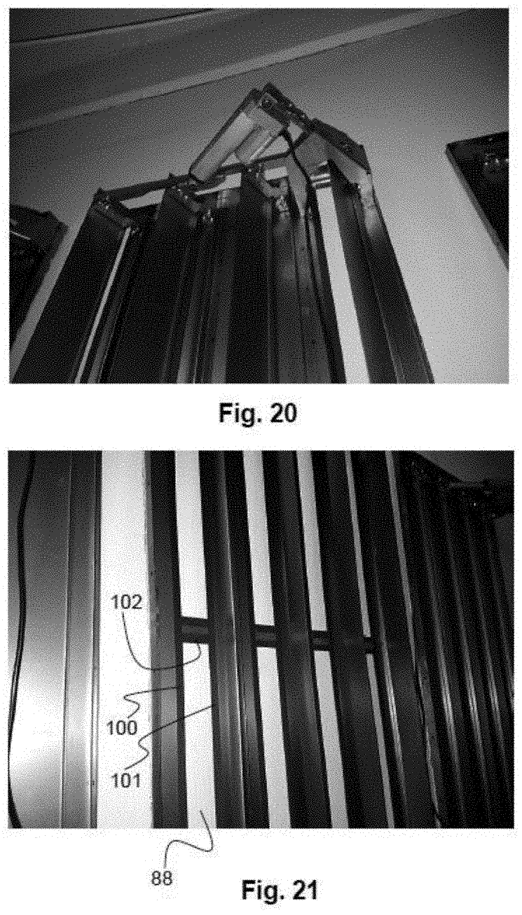

An example of this is shown in the photo shown in FIG. 20. In this manner, the entire contact region between the edge portions of the through-openings in the front face and the corresponding portions of the plate member 56 is in the closed state held firmly and acoustically tight together by the magnetic force provided by the magnetic material. The required pivotal movement of the pivot arm 57 and the plate member 56 is obtained by means of an actuator suitably coupled to the pivot arm 57. An example of a practical implementation of the actuating mechanism will described in connection with FIG. 14.

The inertia moment and the rigidity of the closing plate members (for instance 9 in FIGS. 2 and 3(a), 56 in FIG. 11, 63 in FIGS. 12(a) and (b), 71 in FIGS. 13 and 86 in FIG. 14) can be enhanced by mounting a L-profile or a U-profile on the closing plate members (or forming these as an L-profile or a U-profile). This will have the advantageous effect of minimizing the number of hinges (such as the pivot axle 59 in FIG. 11 or the hinge 13 in FIG. 2) necessary to make the closing plate members sufficiently rigid. Similarly, the front face can be given more stiffness by mounting L-profiles or U-profiles on the rear side of the front face.

With reference to FIG. 12(a) there is shown a schematic representation of a second embodiment of an opening/closing mechanism according to the invention. In this embodiment, the closing of the through-opening 6 in the front face 61, 62 is accomplished by means of a sliding plate member 63, 63′, 63″ of a general U-shape. In the closed state, the legs 63′ and 63″, respectively are brought in contact with corresponding L-shaped edge portions 61′, 62′, respectively of the adjacent portions of the front face 61 and 62, respectively. Magnetic material 64, 65, for instance a magnetic ribbon, is inserted in the respective contact regions between the leg portions of the sliding plate member 63 and the corresponding L-shaped edge portions 61′, 62′ of the front face 61, 62. The required sliding movement as indicated by arrow B can be accomplished be means of a linear actuator 68, the actuator arm 67 of which is attached to the sliding plate member 63 by a suitable bracket 66. This embodiment of an opening/closing mechanism facilitates a very slim configuration of the front face and opening/closing mechanism as indicated by s1 in the figure.

With reference to FIG. 12(b) the opening/closing mechanism according to the second embodiment is shown as seen from above, i.e. from the side of the module that comprises the actuator means shown in FIG. 12(a). As the opening/closing mechanism must provide a substantially acoustically tight closing of the through-openings 6 in the front face when the module is in the closed state, the sliding plate member 63 can be extended laterally by extensions 103 that fit closely in corresponding longitudinal grooves 104 in longitudinally extending side panels 96 and 97 that will be described more detailed in connection with FIG. 18. A small clearance d may be provided between the lateral edge portions of the extensions 103 and the grooves 104, if necessary, but it is important that the extensions fit as closely as possible in the grooves to provide a substantially acoustically tight closing of the module in its closed state.

With reference to FIG. 13 there is shown a schematic representation of a third embodiment of an opening/closing mechanism according to the invention. The opening and closing of the through-opening 6 in the front face 70 is similar to that shown in FIG. 12 comprising a plate member 71 configured to close the through-opening 6 in the front face 70. A magnetic material 72, such as a magnetic ribbon is provided in the contact region between the corresponding edge portions of the plate member 72 and the front face 70. The actuator shaft 73 of a linear actuator 74 is attached to the plate member 73, such that the actuator 74 can move the plate member 71 between a closed position as shown in FIG. 13 and an open position, the movement being indicated by arrow C. This embodiment of an opening/closing mechanism is advantageous due to its simplicity, but requires a larger fitting depth s2 than the one shown in FIG. 12 and would be an advantageous solution in cases where the fitting depth of the opening/closing mechanism (and of the entire module) is not a critical issue.

With reference to FIG. 14 there is shown a schematic illustration of another embodiment of opening/closing means according to the invention. A closing plate 71 is pivotally attached to the front face 70 such that it can pivot about an axle 71′ in close proximity to the front face 70. An appropriate actuator or motor drives the rod 131 in the direction indicated by arrow F, whereby the closing plate 71 closes the through-opening 6 in the front face 70. In order to increase rigidity of the closing plate 71 along the edge portion hereof opposite the pivot axle 71′, the closing plate 71 is provided with an L-profile 129 along the edge portion as shown. Alternatively, the closing plate 71 itself can be designed with an integrated L-shaped (or other appropriately shaped) edge portion. In the closed state, the rod 131 presses the edge portion of the closing plate opposite the pivot axle 71′ firmly against the corresponding edge portion of the through-opening as indicated by arrow F, whereby this edge portion—and hence the entire closing plate 71 is effectively prevented from vibrating in unison with the sound field existing at the through-opening. The edge portions of the front face adjacent the through-opening can furthermore be provided with tightening means 130 for instance felt or rubber ribbons.

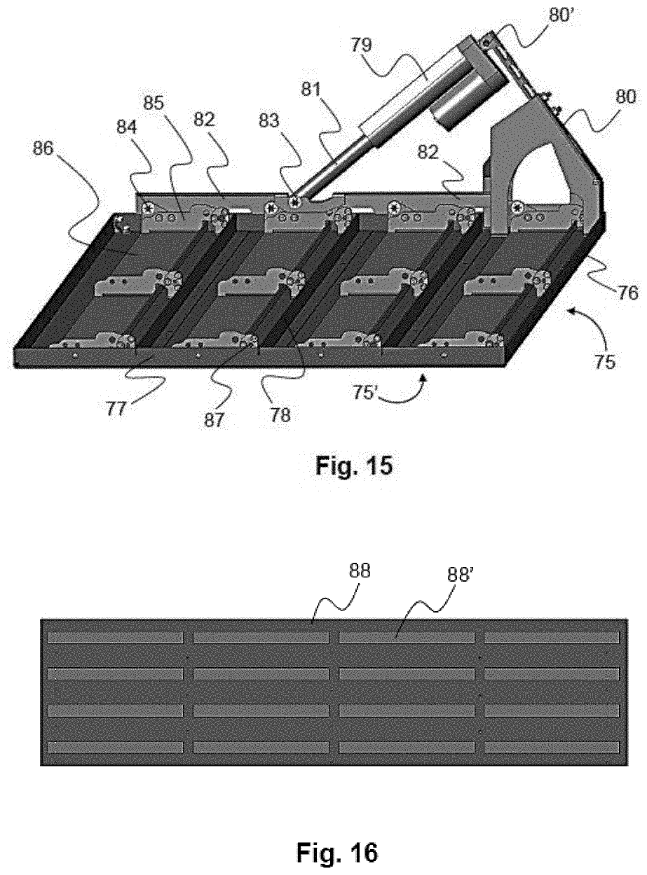

With reference to FIG. 15 there is shown a perspective view of an example of a practical implementation of a front face with a front or exterior surface 75′, (not visible in the figure) with actuator of a module according to the embodiment of the invention showing an embodiment of an opening/closing mechanism according to the embodiment shown in FIG. 11. The front face comprises a frame structure 75 comprising inwardly (i.e. facing the interior of the module in which interior the sound absorbing device or material is located) bended edge portions 76, 77 and an L-profile 78 mounted on the rear side of the front face 78 that add rigidity to the structure. An actuator 79 is pivotally attached at 80′ to a support structure 80 that is firmly attached to the frame structure of the front face. During operation, the actuator 79 can hence pivot about the attachment 80′. The actuator shaft 81 is pivotally attached via a pivot axle 83 to a bar 82 that can move substantially in parallel with the front face. The figure shows a number of pivot arms 85, one longitudinal end of which is attached to the opening/closing plate member 86 and the other longitudinal end of which is attached pivotally (by a hinge) to the frame structure/front face as indicated by reference numeral 87. At the longitudinal end portions of the pivot arm 85, the pivot arm is pivotally attached to the longitudinally extending bar 82. When the actuator shaft 81 is in its extended position as shown in FIG. 14, the opening/closing plate members 86 closes the through-openings 6 in the front face substantively acoustically tight (due to the presence of the magnetic closure means described above) and when the actuator shaft retracts, the pivot arms 85 rotates about the pivot axles 87 and the opening/closing plate members 86 open the respective through-openings 6 provided in the front face.

With reference to FIG. 16 there is shown a plane view of an example of a practical implementation of a front face as seen towards the front surface 75′ (c.f. FIG. 15) of the front face of a module according to an embodiment of the invention, where the front face 88 of the module is provided with a pattern of through-openings 88′. This implementation is an alternative embodiment of the module according to the invention than those described previously in connection with FIGS. 2 and 4, wherein slats 5 of thickness t (c.f. FIG. 4) are assembled to form the front face 4. In those embodiments, the thickness t could be chosen comparatively large, wherefore soft plastic strips 20 could be used to close the unwanted channels formed by the slats. In the embodiment shown in FIG. 16, the through-openings 88′ are simply cut out (or provided otherwise) in the plate forming the front face and the front face (and hence the through-openings) can be very thin. This manner of providing the front face will be advantageous from a manufacturing point of view. Further, in the closed state of the module according to the invention, the front face may present a planar front surface to which a sheet can be mounted.

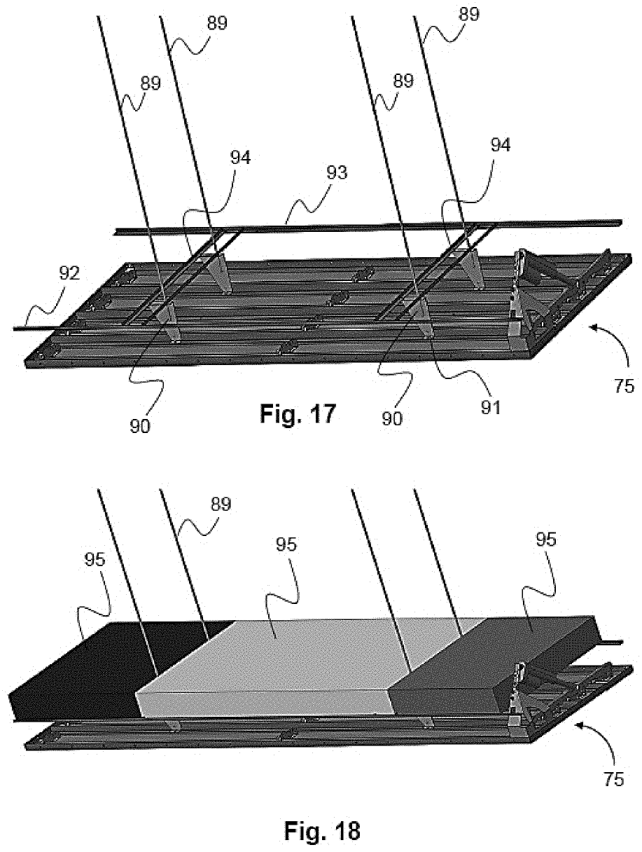

With reference to FIG. 17 there is shown a perspective view of an example of a practical implementation of the front face portion of an embodiment of a module according to the invention as described above and an embodiment of an attachment structure for attaching the module to a boundary of a room. The shown embodiment is particularly (although not necessarily exclusively) suited for modules that are hung from a ceiling. The front face together with the opening/closing mechanism is generally indicated by reference numeral 75 in FIGS. 17 and 18 and is attached to the ceiling by means of a plurality of thin bars or wires 89, of which only four are shown in FIGS. 17 and 18. In practice, a larger number of such bars or wires may be used depending among others on the actual dimensions of the module. The bars or wires 89 terminates in attachment members 90, 91 configured for attachment of the front face to the bars or wires. An upper portion (i.e. a portion above the front face as seen in FIG. 16) of the attachment means 90 is configured to provide a support/attachment for a structure 92, 93, 94 configured to support the sound absorbing device/means on this structure as exemplified in FIG. 17.

With reference to FIG. 18 there is shown a perspective view of an example of a practical implementation of an embodiment of a module according to the invention and an attachment structure for attaching the module to a boundary, such as a ceiling, of a room, where the module is provided with sound absorbing bats 95 above the through-openings 6 through the front face of the module placed on the support structure 92, 93, 94 described above. It is, however understood that other kinds of sound absorbing means than the bats 95 could be used as an alternative or in combination with the bats 95. For instance, one or more sound absorbers of the Helmholz resonator type could be placed above the front face in acoustic communication with one or more through-openings in the front face in order to supplement the LF sound absorption obtained with the module according to the invention with the narrow band sound absorption that can be attained with a suitable tuned Helmholz resonator sound absorber.

As mentioned repeatedly above, it is very important that the modules in the closed state are indeed substantively acoustically tight closed to the surroundings, such that sound energy cannot reach the sound absorbing device in the modules through unintentional openings or slits in the modules (or in a system comprising a plurality of modules according to the invention).

With reference to FIG. 19 there is shown a schematic perspective partly exploded view of an embodiment of a module according to the invention in which the side portions of the module are closed by plate elements 96, 97, 98 and 99 to prevent acoustic energy in the surroundings from reaching the interior space of the module containing the sound absorbing device (such as the sound absorbing bats in the shown embodiment).

With reference to FIG. 20 there is shown a photo showing an example of a practical implementation of an opening/closing mechanism according to the first embodiment shown in FIG. 11. In the photo, the front face is in an open state.

With reference to FIG. 21 there is shown a photo of a module according to an embodiment of the invention seen from the rear side of the front face showing one practical implementation in which the edge portions of the through-openings 88 in the front face are all provided with a magnetic tape or ribbon 100, 101 and 102.

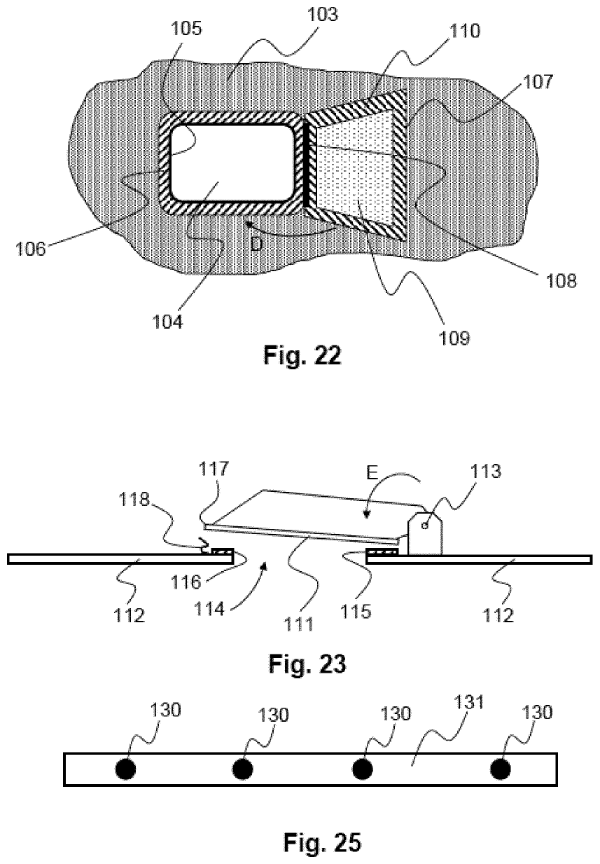

With reference to FIG. 22 there is shown a highly schematic illustration of a closing means according to the invention. A front face 103 is provided with a through-opening 104 and along the entire circumference 105 there is provided a first closing region 106. A closing plated 107 is pivotally mounted on a hinge 108, such that it can close the through opening when moved as indicated by arrow D. The closing plate 107 comprises a region 109 that substantively covers the through-opening in the closed state as well as a second closing region 110 corresponding substantially to the first closing region 106. In order to obtain the required acoustically substantively tight closing of the through-opening, the respective closing regions must according to the invention be maintained in contact with each other in the closed state of the through-openings, such that the closing plate 107 is effectively prevented from undergoing movement in a direction substantially perpendicularly to the front face. Examples of means that can ensure this is the magnetic material shown in FIGS. 11, 12 and 13 as well as the mechanical means shown in FIG. 23. These means—as well as other means obtaining a similar effect—are collectively referred to as retaining means.

With reference to FIG. 23 there is illustrated an opening/closing mechanism that is to a large extend similar to the one shown in FIG. 11 except for the magnetic means shown in FIG. 11 being in the embodiment shown in FIG. 23 replaced by mechanical retaining means in the form of a resilient profile 118 formed to accommodate the edge portion 117 of the closing plate 111, when this is in the closed state. Moving the edge portion 117 into engagement and out of engagement with the resilient profile 118 requires a force that is applied by means of an actuator or motor that is not shown in figured 23. If desired, tightening means 115 and 116 (for instance soft plastic) can be provided in the edge regions of the through-opening 114.

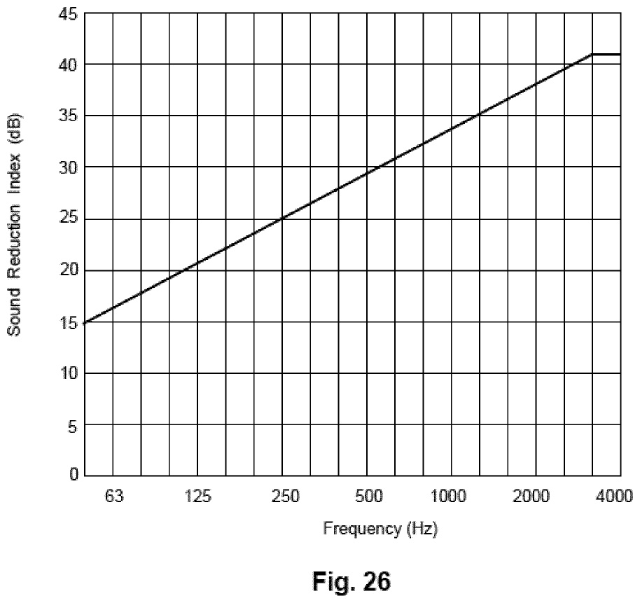

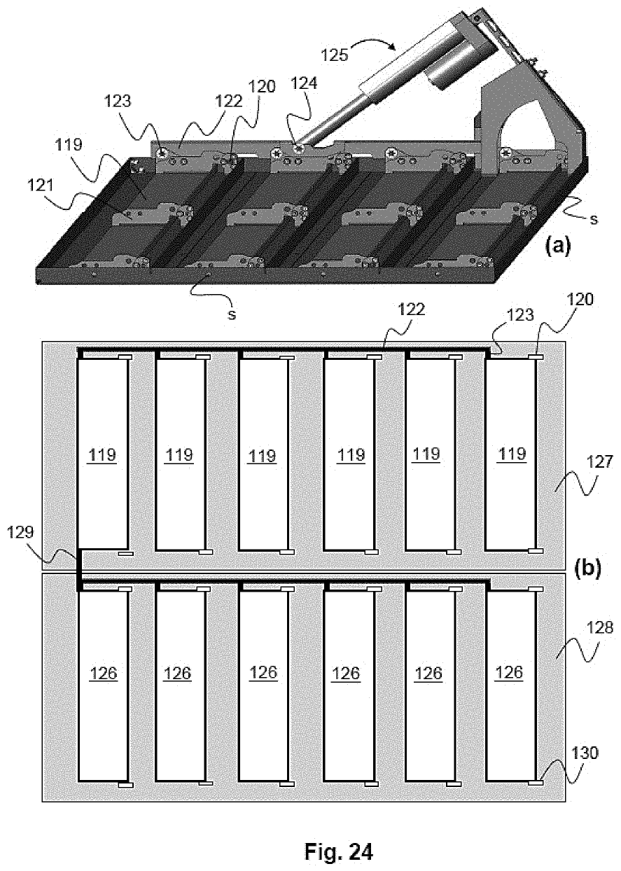

Although the opening/closing mechanism of the modules described above have been driven by a separate actuator or motor for each module, it is according to the invention possible to drive the opening/closing mechanisms of a number of modules by means of a single actuator or motor. An example embodiment of this is shown schematically in FIG. 24(b) where two adjacent front faces 127 and 128, respectively, of the type shown in FIG. 24(a), although with six openings in each front face and not four as in FIG. 24(a), are functionally connected by a rod member 129. For instance, front face 127 can be provided with an actuator or motor in the manner shown in FIG. 24(a) pivotally attached to the bar 122 and thereby being able to pivot the closing plates 119 about respective pivot axles 120 in the manner described above. Due to the connection provided by the rod member 129, the closing plates 126 of the second front face 128 are forced to pivot about their respective pivot axles 130 in unison with the closing plates 119 of the first front face 127.

When modules in a system are installed adjacent to each other, it is important to ensure an acoustically tight connection between the corresponding side portions of the adjacent modules. In FIG. 24, the module shown at the top of the figure is provided with screw holes s by means of which adjacent modules can be screwed together. Tightening means such as a rubber profile possibly supplemented by a sealant can further be introduced between the side surfaces of adjacent modules before these are screwed together to improve the tightening between adjacent modules.

With reference to FIG. 25 there is shown an alternative embodiment of magnetic means used to provide an acoustically tight closing of the opening/closing mechanism of the front faces of the invention. In this embodiment, a plurality of magnets 130 are provided in a strip 131 of for instance soft plastic. The magnets can be either permanent magnets or electro magnets.

With reference to FIG. 26 there is shown a plot of the sound reduction index of a 2 mm thick steel plate with a mass per unit area of 16 kg/m² that as an example can be used to form the front face and the closing plates used the present invention.

Although the invention has been explained in relation to the embodiments described above, it is to be understood that many other possible modifications and variations can be made without departing from the scope of the present invention. Thus, for instance, different kinds of materials can be used for the covering sheet 8 according to specific requirements of a given room or hall and/or different sizes and densities of perforations of the perforations used in the covering sheet can also be used. It is also possible to provide wooden profiles as slats. A gap may be provided on adjacent slats of two neighboring modules, which will make the modules appear as one visually continuous unit. It would also be possible to replace one or more of the modules according to the first aspect of the invention with modules of the same physical dimensions but instead of the described sound absorbing means comprising for instance sound generating means, such as loudspeakers or sound signal providing means (alarms etc.). Thus, for instance, each individual module can be provided with sound emitting means that emits a notification signal in case the module becomes defective.

Furthermore, although the modules and the corresponding front faces according to the invention have generally been described as having a plane surface facing the exterior region or space of the room, this is not a limitation, as the modules and corresponding front faces could alternatively have a curved surface facing the exterior region or space and such curved shapes are also within the scope of the present invention. Similarly, the systems according to the third and fourth aspect of the invention could present curved surfaces facing the exterior region or space. For instance, a system could comprise a plurality of modules or front faces, each having a plane surface facing the exterior region or space, where the individual modules or front faces are tilted relative to each other. Also, the system could comprise modules or front faces with curved surfaces facing the exterior region or space or any combination hereof.

### REFERENCES

[1] Niels Werner Adelman-Larsen et al.: Suitable reverberation times for halls for rock and pop music, JASA, 2010, Vol. 127 and No. 1
[2] Niels Werner Adelman-Larsen et al.: Investigation on acceptable reverberation times at various octave bands in halls that present amplified music; Elsevier, Allied Acoustics, Vol. 129, 2018.
[3] Leo L. Beranek, book: “Acoustics”, 1954.
[4] V. O. Knudsen; Cyril M. Harris, book: “Acoustical Design In Architecture”, 1958.
[5] M. D. Egan, book: “Architectural Acoustics”, 1988.
[6] L. I. Makrinenko, book: “Acoustics of Auditoriums in Public Buildings”, 1994.
[7] Marshall Long, book: “Architectural Acoustics”, 2006.
[8] N. W. Adelman-Larsen, book: Rock and pop venues, Acoustic and architectural design, Springer Verlag, 2014.

1. A module with variable acoustic properties configured for covering boundaries, such as walls or ceilings of a room, for instance a multi-purpose room, in which it must be possible to change the acoustical properties of the room, such as the reverberation time, according to each specific use, where the module has a front face provided with one or more through-openings through which sound energy can enter an inner region of the module, and where the module in the inner region comprises a sound absorbing device in acoustic communication with the through-openings in the front face such that sound energy can pass from an exterior region or space outside the module to said sound absorbing device, where the through-openings can be closed, such that sound energy cannot enter the sound absorbing device via the through-openings and opened, such that sound energy can enter the sound absorbing device via the through-openings, where the front face is provided with an opening/closing mechanism comprising a closing member and a retaining mechanism, which retaining mechanism is configured such that it maintains the closing member in contact with substantively the entire circumference of the through-openings, when the module is in a closed state, characterized in that
said opening/closing mechanism is configured such that it maintains the exterior or front surface of the front face, that faces said exterior region or space unaltered, in all states of the opening/closing mechanism, whereby it becomes possible to attach a covering sheet on the outer surface of the front face or in the vicinity to the outer surface of the front face without the opening/closing mechanism interfering with the covering sheet in any state of the opening/closing mechanism;
said opening/closing mechanism is configured to obtain a substantially acoustically tight closing of said through-openings, where the mechanism comprises a first and a second closing region, where the first closing region is provided on the front face and the second closing region is provided on the closing member, where the mechanism is configured such that it closes the through openings, when the first and second closing regions are in contact with each other and opens the through openings, when the first and second contact regions are not in contact with each other, where said substantially acoustically tight closing of said through-openings is obtained by the retaining means preventing the closing member from undergoing movement in a direction substantially perpendicular to the front face.

2. A module according to claim 1, where said opening/closing mechanism is configured such that the exterior or front surface of the front face is un-broken.

3. (canceled)

4. (canceled)

5. (canceled)

6. (canceled)

7. (canceled)

8. A module according to claim 1, where the exterior or front surface of the front face facing said exterior region or space is covered by a covering sheet that is configured such that it is possible for sound energy to enter the sound absorbing device through the sheet and through the through-openings, when the through openings are in the open state.

9. A module according to claim 8, wherein said covering sheet is made of veneer or foil provided with perforations at least in those regions of the covering sheet that cover said through-openings in the front face.

10. (canceled)

11. (canceled)

12. A module according to claim 1, wherein the opening/closing mechanism is configured to obtain a substantially acoustically tight closing of said through-openings, where the mechanism comprises a first and a second closing face, where the mechanism is configured such that it closes the through openings, when the first and second closing faces are in contact with each other and opens the through openings, when the first and second contact faces are not in contact with each other.

13. A module according to claim 12, where at least one of the first or the second closing faces is provided with magnetic means configured to urge the first closing face against the second closing face, when the mechanism is brought into the closed state.

14. A module according to claim 13, where said first closing face comprises a permanent magnetic material and the second closing face is made of a material that can be attracted by the magnetic material of the first closing face.

15. (canceled)

16. (canceled)

17. A module according to claim 12, where the opening/closing mechanism comprises a pivotally mounted plate member that is configured to pivot about a pivot axle in fixed relationship with the front face, such that the plate member can pivot between a closed state, where the plate member closes the through-opening in the front face and an open state, where the plate member does not close the through-opening, where the plate member is provided with said first closing face and the front plate on a corresponding portion is provided with said second closing face.

18. (canceled)

19. (canceled)

20. (canceled)

21. A module according to claim 12, where the opening/closing mechanism comprises a sliding plate member mounted for a sliding movement substantially in parallel with the front face, such that the sliding plate member can move between a closed state, in which it closes the through opening in the front face and on open state, in which it does not close the through opening in the front face, where the sliding plate member at opposing edge portions in the direction of movement is provided with leg portions, such that the sliding plate member has a general U-shape, and where the front face is provided with corresponding leg portions at the edges of the through opening extending perpendicularly to the direction of movement of the sliding plate member, such that one leg portion of the sliding plate member corresponds to one leg portion of the front plate and the other leg portion of the sliding plate member corresponds to the other leg portion of the front face, where the first leg portion of the sliding plate member in the closed state of the opening/closing mechanism is substantially in contact with the corresponding leg portion of the front face and the other leg portion of the sliding plate member is substantially in contact with the corresponding leg portion of the front face, whereby the through opening in the fornt face is substantially closed.

22. (canceled)

23. (canceled)

24. A module according to claim 12, where the opening/closing mechanism comprises an opening/closing plate member extending substantially perpendicular to the front face and covering the through opening in the front face, such that an overlapping closing face is formed between the edge portions of the plate member and the corresponding edge regions of the front face adjacent to the through opening, where the opening/closing mechanism comprises actuator means connected to the plate member configured to move the plate member in a direction substantively perpendicular to the front face between a closed state, in which the plate member closes the through opening and an open state, in which the plate member does not close the through opening.

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. A front face comprising a plurality of through-openings through which sound energy can pass, when the through-openings are in an open state, where the front face is provided with an opening/closing mechanism configured for opening and closing said through-openings, where the opening/closing mechanism comprises a closing member and a retaining mechanism, which retaining mechanism is configured such that it maintains the closing member in contact with substantively the entire circumference of the through-openings, when the module is in a closed state, characterized in that
said opening/closing mechanism is configured such that it maintains the exterior or front surface of the front face, that faces said exterior region or space unaltered, in all states of the opening/closing mechanism, whereby it becomes possible to attach a covering sheet on the outer surface of the front face or in the vicinity to the outer surface of the front face without the opening/closing mechanism interfering with the covering sheet in any state of the opening/closing mechanism;
said opening/closing mechanism is configured to obtain a substantially acoustically tight closing of said through-openings, where the mechanism comprises a first and a second closing region, where the first closing region is provided on the front face and the second closing region is provided on the closing member, where the mechanism is configured such that it closes the through openings, when the first and second closing regions are in contact with each other and opens the through openings, when the first and second contact regions are not in contact with each other. where said substantially acoustically tight closing of said through-openings is obtained by the retaining means preventing the closing member from undergoing movement in a direction substantially perpendicular to the front face.

40. A front face according to claim 39, where said opening/closing mechanism is configured such that it opens in an inward direction away from the exterior or front surface of the front face, such that it maintains an un-broken exterior surface of the front face facing.

41. (canceled)

42. (canceled)

43. (canceled)

44. (canceled)

45. (canceled)

46. A front face according to claim 39, wherein said opening/closing mechanism is configured to obtain a substantially acoustically tight closing of said through-openings, where the mechanism comprises a first and a second closing face, where the mechanism is configured such that it closes the through openings, when the first and second closing faces are in contact with each other and opens the through openings, when the first and second contact faces are not in contact with each other, wherein at least one of the first or the second closing faces is provided with magnetic means configured to urge the first closing face against the second closing face, when the mechanism is brought into the closed state, wherein said first closing face comprises a permanent magnetic material and the second closing face is made of a material that can be attracted by the magnetic material of the first closing face.

47. (canceled)

48. (canceled)

49. (canceled)

50. (canceled)

51. A front face according to claim 46, where the opening/closing mechanism comprises a pivotally mounted plate member that is configured to pivot about a pivot axle in fixed relationship with the front face, such that the plate member can pivot between a closed state, where the plate member closes the through-opening in the front face and an open state, where the plate member does not close the through-opening, where the plate member is provided with said first closing face and the front plate on a corresponding portion is provided with said second closing face.

52. (canceled)

53. A front face according to claim 51, wherein one of the closing faces are provided with a permanent magnetic material, such as a magnetic ribbon, and the other closing face is made of a material that can be attracted by a magnetic force from the magnetic material provided on the opposing closing face.

54. (canceled)

55. A front face according to claim 39, where the opening/closing mechanism comprises a sliding plate member mounted for a sliding movement substantially in parallel with the front face, such that the sliding plate member can move between a closed state, in which it closes the through opening in the front face and on open state, in which it does not close the through opening in the front face, wherein the sliding plate member at opposing edge portions in the direction of movement is provided with leg portions, such that the sliding plate member has a general U-shape, and where the front face is provided with corresponding leg portions at the edges of the through opening extending perpendicularly to the direction of movement of the sliding plate member, such that one leg portion of the sliding plate member corresponds to one leg portion of the front plate and the other leg portion of the sliding plate member corresponds to the other leg portion of the front face, where the first leg portion of the sliding plate member in the closed state of the opening/closing mechanism is substantially in contact with the corresponding leg portion of the front face and the other leg portion of the sliding plate member is substantially in contact with the corresponding leg portion of the front face, whereby the through opening in the fornt face is substantially closed.

56. (canceled)

57. (canceled)

58. A front face according to claim 39, where the opening/closing mechanism comprises an opening/closing plate member extending substantially in perpendicular the front face and covering the through opening in the front face, such that an overlapping closing face is formed between the edge portions of the plate member and the corresponding edge regions of the front face adjacent to the through opening, where said closing face at an edge portion thereof is provided with resilient retaining means configured to maintain said closing face in a fixed relationship to the front face, where the opening/closing mechanism comprises actuator means connected to the plate member configured to move the plate member in a direction substantively perpendicular to the front face between a closed state, in which the plate member closes the through opening and an open state, in which the plate member does not close the through opening.

59. (canceled)

60. (canceled)

61. (canceled)

62. A system with variable acoustic properties configured for covering boundaries, such as walls or ceilings of a room, for instance a multi-purpose room, in which it must be possible to change the acoustical properties of the room, such as the reverberation time, according to each specific use, where the system comprises a plurality of modules according to claim 1, where the individual modules are in communication with a control unit, such that the control unit can control the opening/closing of the through-openings in each individual module by controlling the corresponding opening/closing mechanisms of the individual modules.

63. A system according to claim 62, where the system comprises a user interface functionally in communication with the control unit, whereby the reverberation time of the room in which the modules are provided can be controlled by a user by opening/closing each individual of the modules.

64. A system according to claim 62, where the system comprises an electronic memory in which corresponding settings (open/close state) of each individual module can be stored for instance together with a description of the kind of performance for which the obtained reverberation time is regarded as optimal.

65. (canceled)

66. (canceled)

67. (canceled)

68. (canceled)

69. (canceled)

70. (canceled)

71. (canceled)

72. (canceled)

73. (canceled)

74. (canceled)

75. (canceled)

76. (canceled)

77. (canceled)

78. (canceled)

79. (canceled)

80. (canceled)

81. (canceled)

82. (canceled)
